(19) United States
(12) Patent Application Publication
(10) Pub. No.: US 2025/0314119 A1
(43) Pub. Date: Oct. 9, 2025

(54) AUTOMATED SPACER PROCESSING SYSTEMS AND METHODS

(71) Applicant: Cardinal IG Company, Eden Prairie, MN (US)

(72) Inventors: Robert C. Buchanan, Spring Green, WI (US); Michael J. Milewski, Poynette, WI (US); Daniel Todd Butson, Pardeeville, WI (US); Karl Chic, Baraboo, WI (US)

(21) Appl. No.: 19/208,313

(22) Filed: May 14, 2025

Related U.S. Application Data
(63) Continuation-in-part of application No. 18/146,194, filed on Dec. 23, 2022, now Pat. No. 12,320,185.
Application No. 18/146,194 is a continuation of application No. 16/882,107, filed on May 22, 2020, now Pat. No. 11,536,083.

(51) Int. Cl. E06B 3/673; B25J 9/00; B25J 9/16; B25J 15/00; B29C 65/00; B29C 65/48; B29C 65/78; B29K 709/08; B29L 31/00; E06B 3/663

(52) U.S. Cl. CPC E06B 3/67326; B25J 9/0093; B25J 9/1682; B25J 9/1687; B25J 15/0028; B25J 15/0061; B29C 65/48; B29C 65/7841; B29C 65/787; B29C 66/7465; B29C 66/863; E06B 3/66342; B29K 2709/08; B29L 2031/7782

(57) ABSTRACT

The invention provides automated spacer processing systems and methods. The systems and methods involve at least one robot arm, at least one sealant applicator, or both. The systems and methods are configured to process spacers for multiple-pane IG units. In some embodiments, the systems include an IG unit assembly line, a spacer conveyor system, or both.

### RELATED APPLICATIONS

This is a continuation-in-part of Application No. 18/146, 194, filed Dec. 23, 2022, which is a continuation of Application No. 16/882, 107, filed May 22, 2020, and issued on Dec. 27, 2022 as U.S. Pat. No. 11,536,083, the contents of each of which are incorporated herein by reference.

### TECHNICAL FIELD

The present disclosure relates generally to equipment and methods for processing spacers for insulating glass units. More particularly, this disclosure relates to automated equipment and methods for processing such spacers.

### BACKGROUND

In the manufacturing facilities that produce insulating glass units, spacers are sometimes transported by a conveyor. In some cases, it is desirable at a given location to remove the spacers from the conveyor and attach each spacer onto a glass sheet. This has been done manually, e.g., by workers physically grabbing a spacer off an overhead conveyor and thereafter attaching it onto a glass sheet located on a nearby IG unit assembly line. In addition, certain automated spacer processing techniques have been disclosed.

It would be desirable to provide automated equipment and methods for processing spacers for IG units. In some cases, this may involve a robot removing the spacers from a conveyor and attaching them to respective glass sheets. It would be particularly desirable to provide equipment and methods of this nature that offer the ability to handle spacers securely, reliably, and on an adjustable basis, e.g., such that the equipment is adjustable to process spacers of different sizes, different shapes, or both. It would be particularly desirable, for example, to provide such equipment with an adjustable gripper configured to grip spacers of different sizes and shapes. In addition, it would be desirable to provide automated equipment and methods for applying sealant to spacers.

### SUMMARY

In certain embodiments, the invention provides a robotic spacer processing system that includes an insulating glazing unit assembly line, a spacer conveyor system, and a first robot arm. The spacer conveyor system can include a spacer conveyor line along which spacers can be conveyed. The first robot arm is equipped with a first gripper frame. The robotic spacer processing system has first and second positions. The robotic spacer processing system when in the first position has the first gripper frame holding a spacer adjacent the spacer conveyor line. The robotic spacer processing system when in the second position has the first gripper frame holding the spacer adjacent the insulating glazing unit assembly line.

Some embodiments of the invention provide a robotic spacer processing system that includes an insulating glazing unit assembly line, a spacer conveyor system, a sealant applicator, and a first robot arm. The spacer conveyor system can include a spacer conveyor line along which spacers can be conveyed. The first robot arm is equipped with a first gripper frame. The robotic spacer processing system has a first position, an intermediate position, and a second position. The robotic spacer processing system when in the first position has the first gripper frame holding a spacer adjacent the spacer conveyor line. The robotic spacer processing system when in the intermediate position has the first gripper frame holding the spacer adjacent the sealant applicator. The robotic spacer processing system when in the second position has the first gripper frame holding the spacer adjacent the insulating glazing unit assembly line.

Certain embodiments of the invention provide a robotic spacer processing system comprising a first robot arm. In the present embodiments, the first robot arm is a multi-axis robot arm with six axes of rotation. The first robot arm is equipped with a first gripper frame. Preferably, the first gripper frame has a plurality of grippers configured to grip a spacer.

In some embodiments, the invention provides a method of operating a robotic spacer processing system comprising an insulating glazing unit assembly line, a spacer conveyor system, a sealant applicator, and a first robot arm. In the present embodiments, the first robot arm is equipped with a first gripper frame, the robotic spacer processing system has an intermediate position, the robotic spacer processing system when in the intermediate position has the first gripper frame holding a spacer adjacent the sealant applicator, and the robotic spacer processing system when in the intermediate position is configured to apply sealant onto opposed sides of the spacer. The present method includes applying the sealant onto the spacer by operating the first robot arm to move the spacer along a nozzle of the sealant applicator so as to apply the sealant along all legs of the spacer, preferably while the first robot arm maintains the spacer in an upright rotationally-fixed position.

In certain embodiments, the invention provides a method of operating a robotic spacer processing system comprising a sealant applicator and a robot arm. In the present embodiments, the sealant applicator includes two confronting nozzles having a sealant-application zone between them. Preferably, the method includes operating the robot arm so as to move the spacer through the sealant-application zone while operating the two confronting nozzles to apply sealant onto two opposed sides of the spacer, wherein the method includes rotating the two confronting nozzles about the sealant-application zone.

Some embodiments of the invention provide a sealant applicator configured to apply sealant onto two opposed sides of a spacer. Preferably, the sealant applicator includes two confronting nozzles having a sealant-application zone between them, with the two confronting nozzles being rotatable about the sealant-application zone.

Certain embodiments of the invention provide a robotic spacer processing system comprising a robot arm and a sealant applicator. The robot arm is equipped with a gripper frame, and the gripper frame includes a plurality of grippers configured to hold a spacer. In the present embodiments, the sealant applicator includes two confronting nozzles that have a sealant-application zone between them and are configured to apply sealant onto two opposed sides of the spacer. Preferably, the grippers are retractable grippers that are each movable between an engaged position and a disengaged position. Furthermore, the sealant applicator preferably is located at an elevated position such that a bottom leg of the spacer is at a lower elevation than a top leg of the spacer while the two confronting nozzles are applying sealant onto the two opposed sides of the spacer along the top leg of the spacer.

In some embodiments, the invention provides a robotic spacer processing system comprising a robot arm and an insulating glazing unit assembly line. In certain embodiments of this nature, the robotic spacer processing system includes a sealant applicator that is integral to the insulating glazing unit assembly line. Furthermore, the sealant applicator preferably includes two confronting nozzles having a sealant-application zone between them. In embodiments of this nature, the robot arm preferably is configured to move the spacer through the sealant-application zone of the sealant applicator while operating the two confronting nozzles to apply sealant onto two opposed sides of the spacer.

The details of one or more examples are set forth in the accompanying drawings and the description below. Other features, objects, and advantages will be apparent to skilled artisans given the present descriptions, drawings, and claims.

### BRIEF DESCRIPTION OF DRAWINGS

FIG. 1 is a perspective view of a robotic spacer processing system in accordance with certain embodiments of the present invention, with a first robot arm of the system shown in a start position.

FIG. 2 is an end view of the spacer processing system of FIG. 1.

FIG. 3 is another perspective view of the robotic spacer processing system of FIG. 1, with the first robot arm shown in a first position.

FIG. 4 is an end view of the spacer processing system of FIG. 3.

FIG. 5 is still another perspective view of the robotic spacer processing system of FIG. 1, with the first robot arm shown in a sealing position.

FIG. 6 is an end view of the spacer processing system of FIG. 5.

FIG. 7 is yet another perspective view of the robotic spacer processing system of FIG. 1, with the first robot arm shown in another sealing position.

FIG. 8 is an end view of the spacer processing system of FIG. 7.

FIG. 9 is still another perspective view of the robotic spacer processing system of FIG. 1, with the first robot arm shown in a second position.

FIG. 10 is an end view of the spacer processing system of FIG. 9.

FIG. 11 is yet another perspective view of the robotic spacer processing system of FIG. 1, with the first robot arm shown in another second position.

FIG. 12 is an end view of the spacer processing system of FIG. 11.

FIG. 13 is still another perspective view of the robotic spacer processing system of FIG. 1, with the first robot arm shown in an adhering position.

FIG. 14 is an end view of the spacer processing system of FIG. 13.

FIG. 15 is yet another perspective view of the robotic spacer processing system of FIG. 1, with the first robot arm shown in a retracting position.

FIG. 16 is an end view of the spacer processing system of FIG. 15.

FIG. 17A is a side view of a robotic spacer processing system in accordance with certain embodiments of the invention where the system includes two robot arms.

FIG. 17B is a top view of the robotic spacer processing system of FIG. 17A.

FIG. 17C is an end view of the robotic spacer processing system of FIG. 17A.

FIG. 18A is a perspective view of a gripper frame in accordance with certain embodiments of the present invention, shown holding a first spacer.

FIG. 18B is a front view of the gripper frame of FIG. 18A.

FIG. 18C is a side view of the gripper frame of FIG. 18A.

FIG. 19A is a perspective view of the gripper frame of FIG. 18A, shown holding a second spacer, which is smaller than the first spacer.

FIG. 19B is a front view of the gripper frame of FIG. 19A.

FIG. 19C is a side view of the gripper frame of FIG. 19A.

FIG. 20A is a perspective view of the gripper frame of FIG. 18A, shown holding a third spacer, which is smaller than the second spacer.

FIG. 20B is a front view of the gripper frame of FIG. 20A.

FIG. 20C is a side view of the gripper frame of FIG. 20A.

FIG. 21 is a cross-sectional view of various spacer configurations that can be used with the present equipment and methods; FIG. 21A is a cross-sectional view of a spacer configuration that can be used with the present equipment and methods; FIG. 21B is a cross-sectional view of another spacer configuration that can be used with the present equipment and methods; FIG. 21C is a cross-sectional view of still another spacer configuration that can be used with the present equipment and methods; FIG. 21D is a cross-sectional view of yet another spacer configuration that can be used with the present equipment and methods; FIG. 21E is a cross-sectional view of still another spacer configuration that can be used with the present equipment and methods; FIG. 21F is a cross-sectional view of yet another spacer configuration that can be used with the present equipment and methods; and FIG. 21G is a cross-sectional view of still another spacer configuration that can be used with the present equipment and methods.

FIG. 22 is a broken-away, perspective view of a gripper frame holding a spacer so as to move the spacer along a nozzle of a sealant applicator in accordance with certain embodiments of the present invention, with sealant being applied onto both sides of a bottom leg of the spacer.

FIG. 23 is another broken-away, perspective view of the gripper frame of FIG. 22 holding the spacer so as to move the spacer along the nozzle of the sealant applicator in accordance with certain embodiments of the invention, with sealant being applied onto both sides of a first side leg of the spacer.

FIG. 24 is still another broken-away, perspective view of the gripper frame of FIG. 22 holding the spacer so as to move the spacer along the nozzle of the sealant applicator in accordance with certain embodiments of the invention, with sealant being applied onto both sides of a top leg of the spacer.

FIG. 25 is yet another broken-away, perspective view of the gripper frame of FIG. 22 holding the spacer so as to move the spacer along the nozzle of the sealant applicator in accordance with certain embodiments of the invention, with sealant being applied onto both sides of a second side leg of the spacer.

FIG. 26 is a partially broken-away, schematic side view of two confronting nozzles of a sealant applicator in accordance with certain embodiments of the invention.

FIG. 27 is a perspective view of a robotic spacer processing system in accordance with certain embodiments of the invention, with two robot arms of the system omitted for purposes of illustrating two sealant applicators of the system.

FIG. 28 is a perspective view of the robotic spacer processing system of FIG. 27, with the two robot arms of the system shown.

FIG. 29 is a broken-away, perspective view of an insulating glazing unit assembly line having a sealant applicator integrated into the insulating glazing unit assembly line in accordance with certain embodiments of the invention, with the sealant applicator oriented to apply sealant onto both sides of a bottom leg of the spacer.

FIG. 30 is another broken-away, perspective view of the insulating glazing unit assembly line of FIG. 29, with the sealant applicator oriented to apply sealant onto both sides of a first side leg of the spacer.

FIG. 31 is still another broken-away, perspective view of the insulating glazing unit assembly line of FIG. 29, with the sealant applicator oriented to apply sealant onto both sides of a top leg of the spacer.

FIG. 32 is yet another broken-away, perspective view of the insulating glazing unit assembly line of FIG. 29, with the sealant applicator oriented to apply sealant onto both sides of a second side leg of the spacer.

FIG. 33 is a broken-away perspective view of the two sealant applicators of the system shown in FIG. 27;

FIG. 34 is a side view of a gripper in accordance with certain embodiments of the invention, with two fingers of the gripper shown in an open position;

FIG. 35 is another side view of the gripper of FIG. 34, with the two fingers of the gripper shown in a closed position.

FIG. 36 is a side view of the gripper of FIG. 34 operably positioned for gripping a spacer, with the two fingers of the gripper shown in an open position.

FIG. 37 is a side view of the gripper of FIG. 36, with the two fingers shown in a closed position and gripping the spacer;

FIG. 38 is a side view of a dispenser head of a sealant applicator in accordance with certain embodiments of the present invention;

FIG. 39 is a perspective view of the dispenser head of FIG. 38;

FIG. 40 is another perspective view of the dispenser head of FIG. 38; and

FIG. 41 is a cross-sectional view of various shape examples for the IG units and spacers that can be used in accordance with the equipment and methods described herein.

### DETAILED DESCRIPTION

The invention provides a robotic spacer processing system, which is identified by reference number 1. The robotic spacer system 1 is configured to process spacers 50 for multiple-pane insulating glazing units 100 (“IG units”). The IG units can be double-pane IG units or triple-pane IG units.

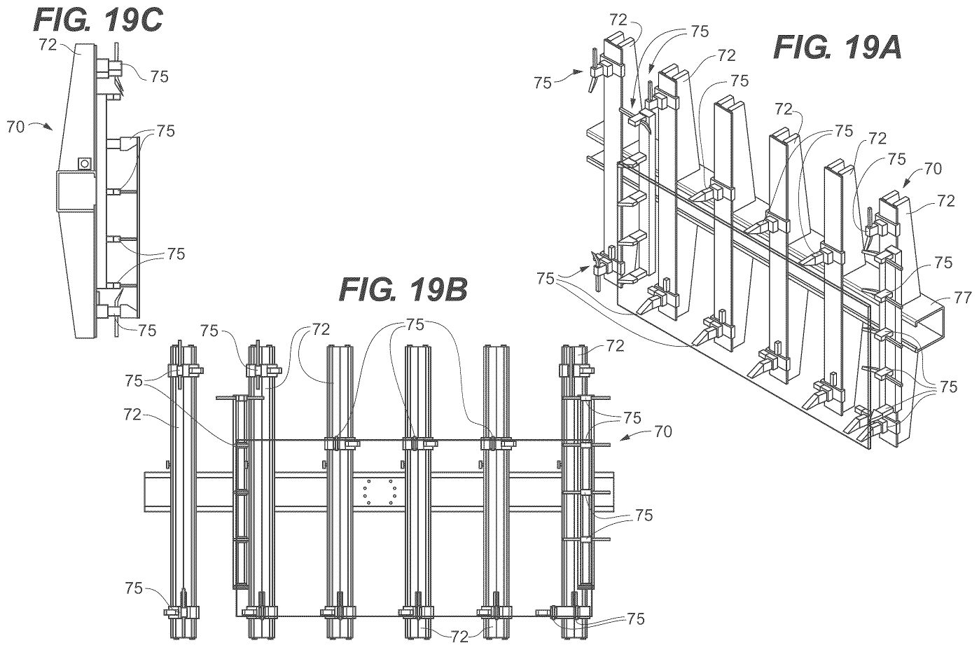

Many different types of spacers can be used in multiple-pane insulating glazing units. The present systems can process a variety of different spacer types. FIG. 21 shows several non-limiting examples of spacer types that can be used. In some cases, the spacers processed by the present systems, and used in the present methods, comprise or consist of a metal, such as stainless steel or another alloy, aluminum, titanium or another aircraft metal, or some other suitable metal. Reference is made to the first four spacer profiles shown in FIG. 21. Alternatively, the spacer can consist of a polymer. Reference is made to the fifth and seventh spacer profiles shown in FIGS. 21. In other cases, the spacer can comprise both a metal and a polymer. For example, a plastic spacer body can be provided with a metal moisture barrier layer. Reference is made to the sixth spacer profile shown in FIG. 21. Another possibility is to use a spacer with two opposed side walls of plastic and two opposed top walls of metal.

The robotic spacer processing system 1 comprises a first robot arm 10. The first robot arm 10 has multiple axes of rotation (i.e., it is a multi-axis robot arm), preferably including a vertical axis of rotation, and perhaps optimally also including a horizontal axis of rotation. The first robot arm 10 desirably has four or more (e.g., six) axes of rotation. Suitable robot arms are commercially available from Fanuc of Yamanashi, Japan, for example, under model number R2000iC/165.

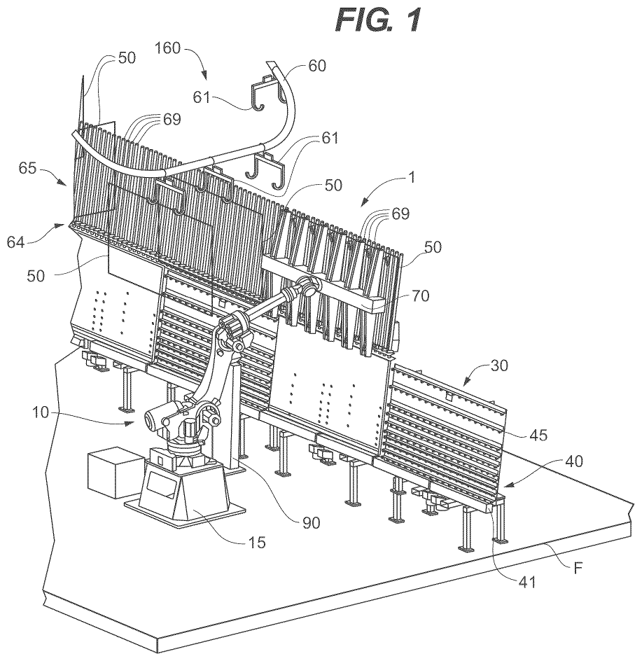

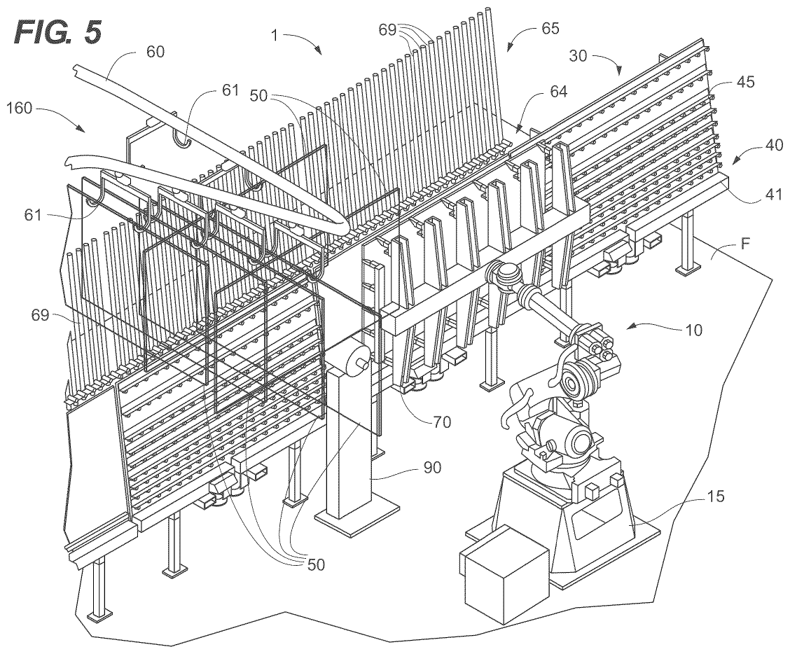

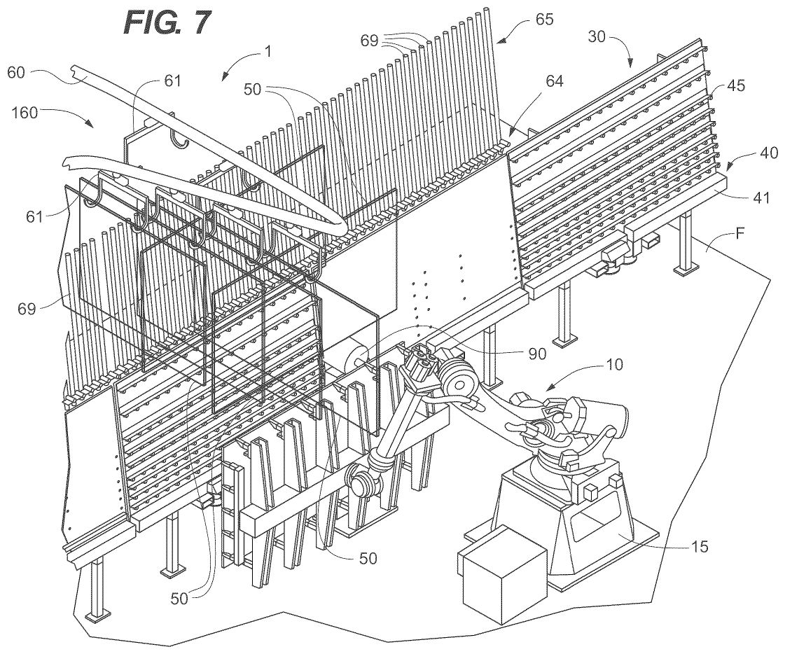

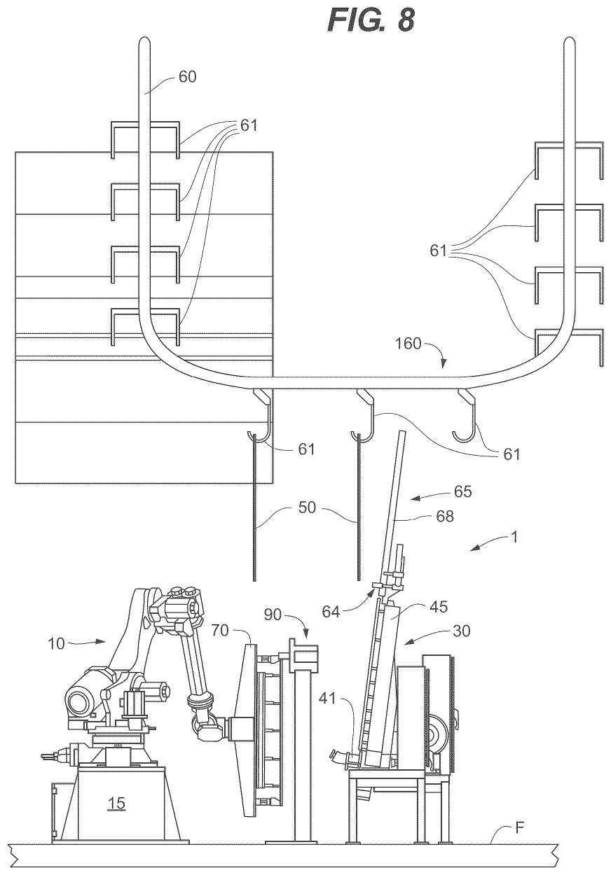

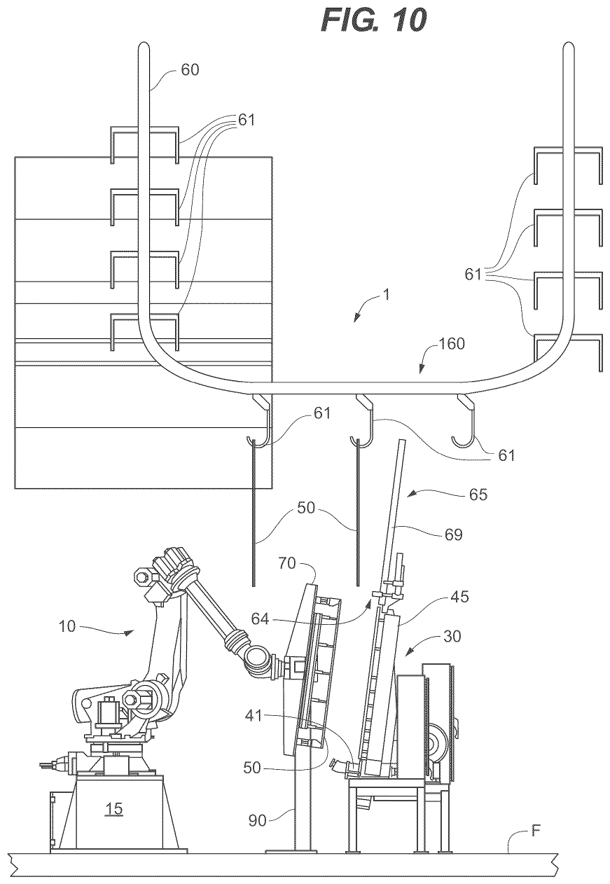

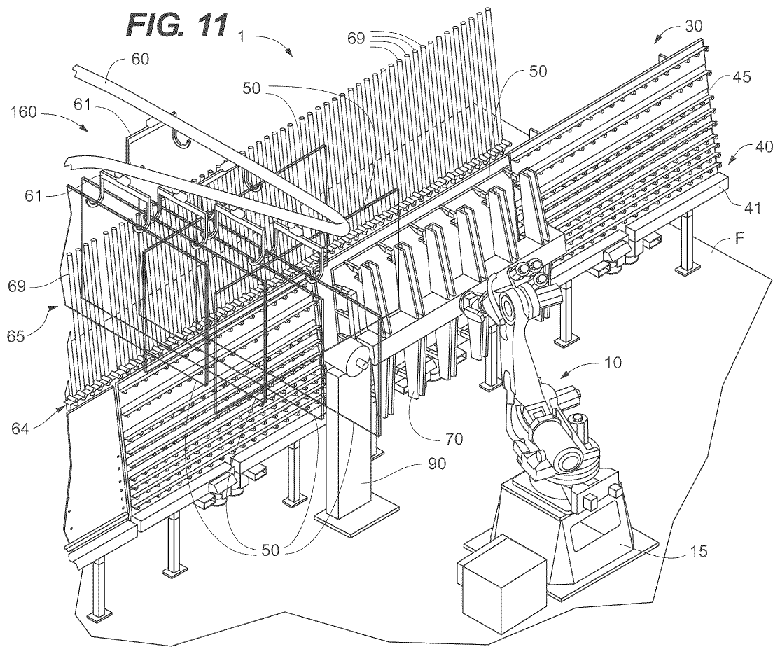

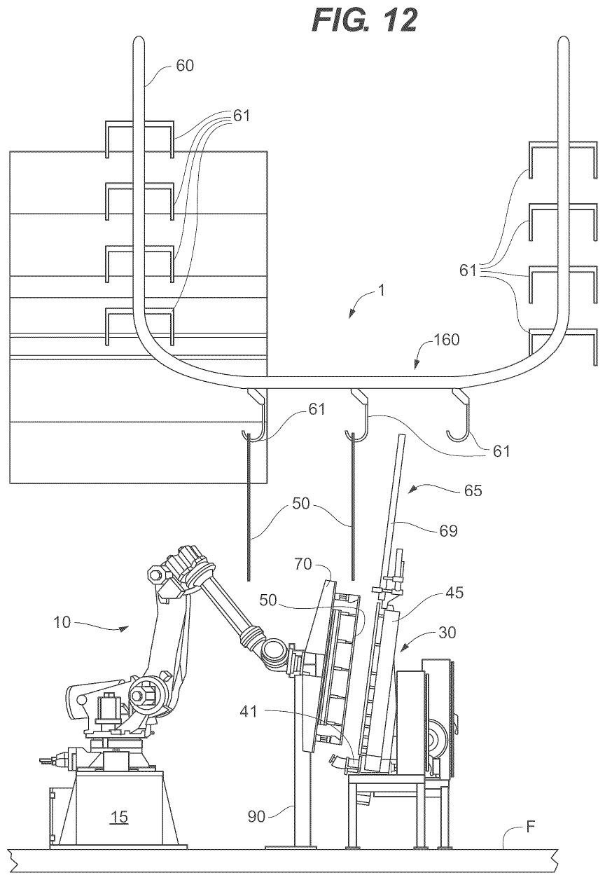

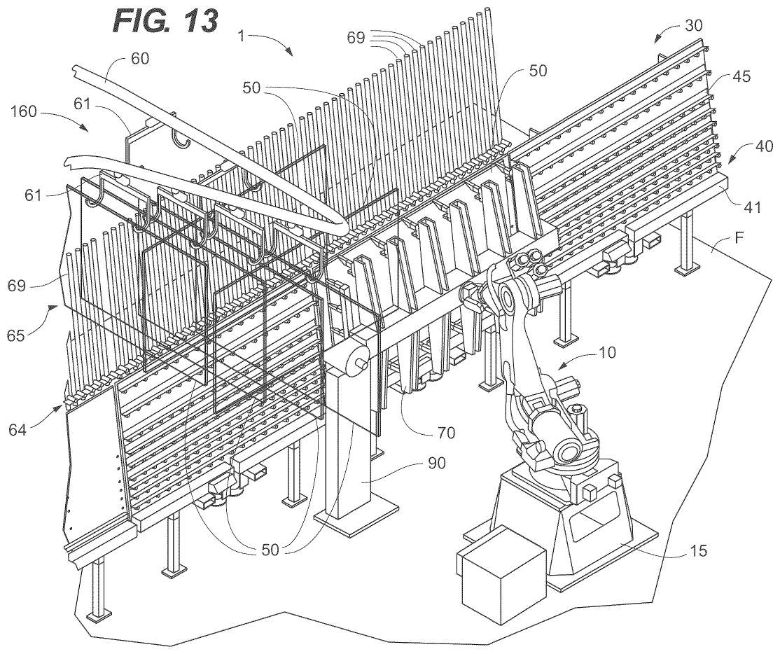

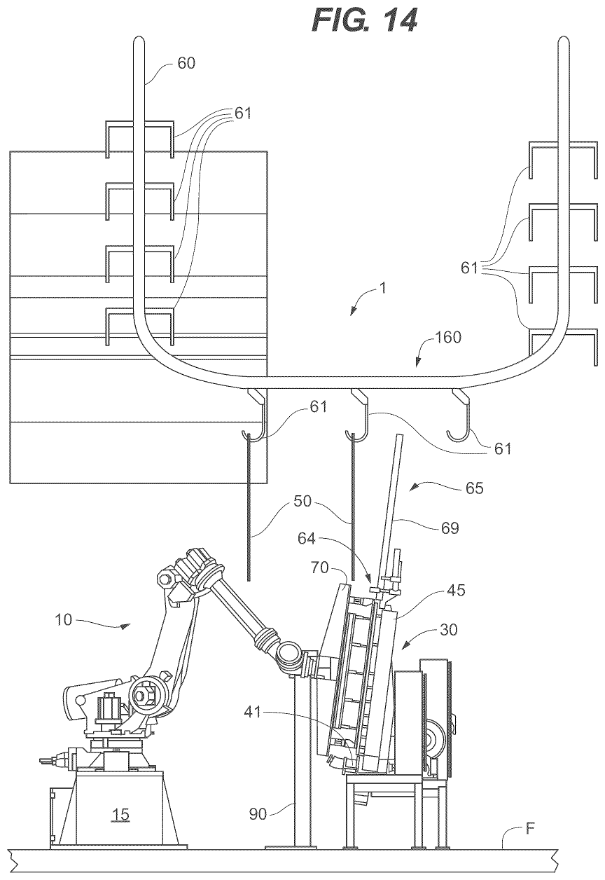

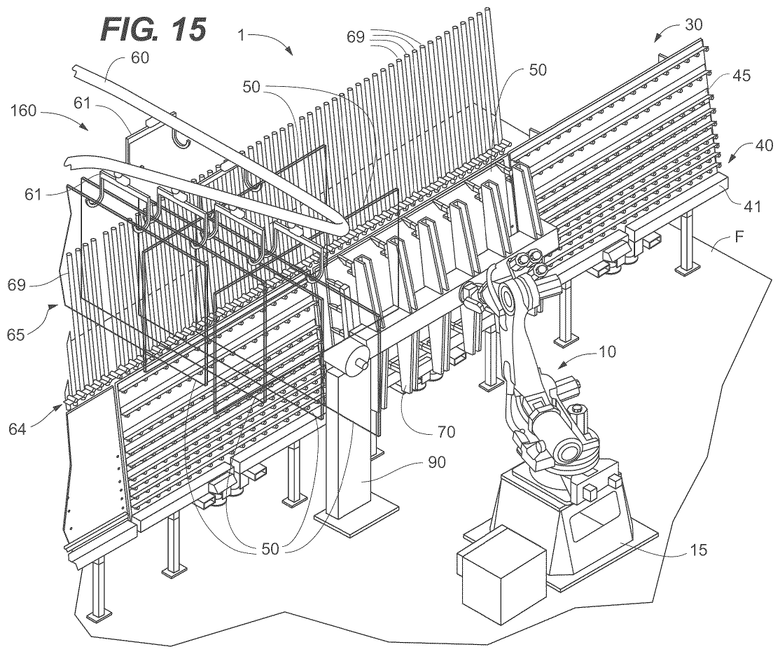

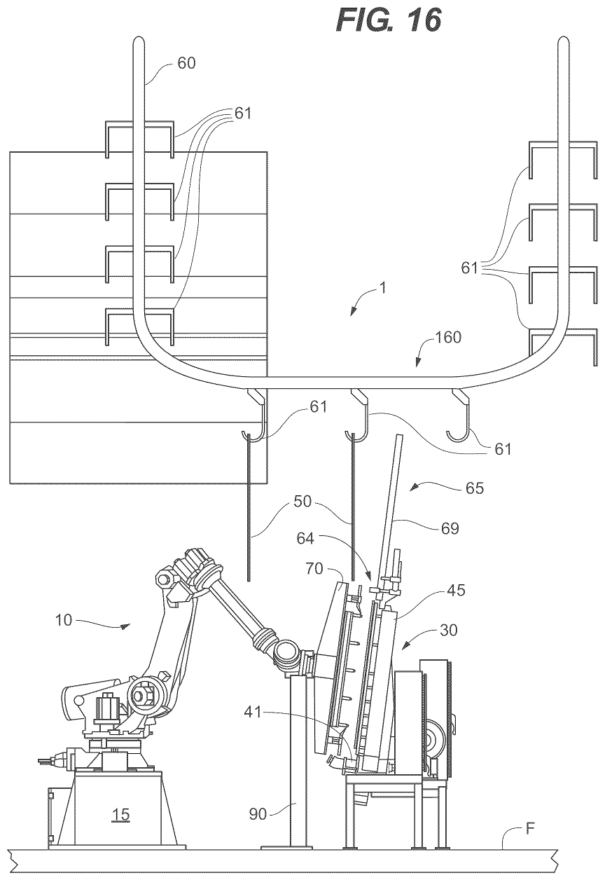

Preferably, the first robot arm 10 has a mount base 15 that is mounted to a floor F. This is shown, for example, in FIGS. 1-16. Here, it can be appreciated that the illustrated first robot arm 10 has multiple axes of rotation, including a vertical axis of rotation. Thus, the first robot arm preferably is an articulated robot having multiple rotary joints that provide multiple axes of rotation. The rotary joints, and the resulting axes of rotation, preferably are at locations spaced apart in series along the first robot arm. In more detail, starting from a base of the first robot arm and moving toward a working end thereof, each rotary joint located closer to the base preferably supports one or more rotary joints located closer to the first robot arm's working end (which carries the first gripper frame). Thus, starting from the base, each rotary joint preferably supports (e.g., provides an additional degree of motion freedom to) the rotary joints further along the robot arm. The robot arm preferably comprises multiple servo motors, e.g., one for each rotary joint. In the embodiments illustrated, the first robot arm 10 has a first (counting in sequence from the base toward the working end) rotary axis that is vertical and a subsequent (e.g., second) rotary axis that is horizontal. This can optionally be the case for any embodiment of the present disclosure. While the first robot arm is shown mounted to the floor, it can alternatively be suspended from an overhead frame or the like.

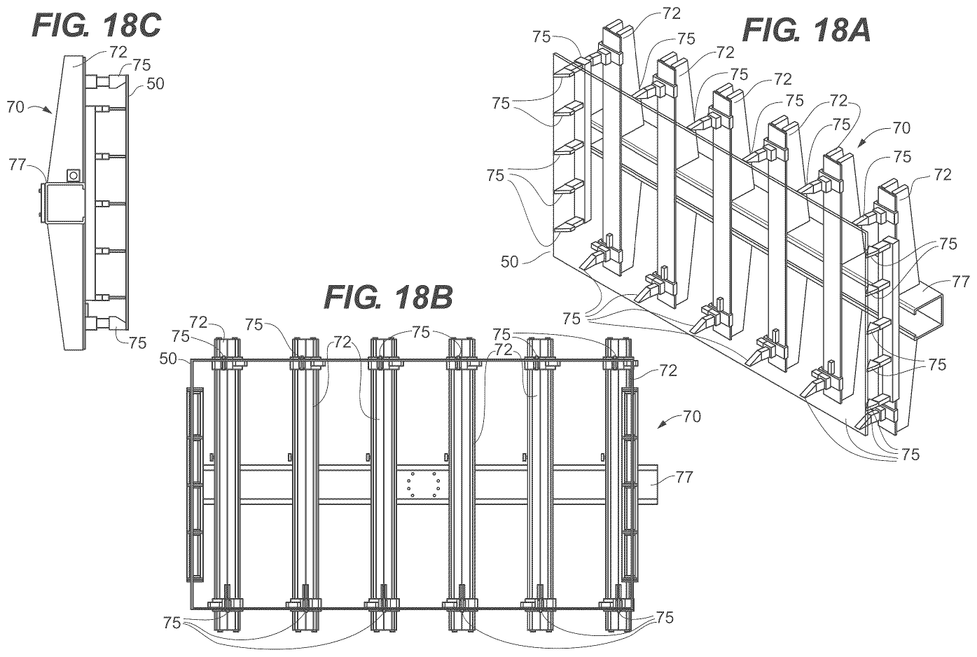

The first robot arm 10 is equipped with a first gripper frame 70, which is configured to grip a spacer 50. Reference is made to FIGS. 1-16 and 18A-20C. In more detail, the first gripper frame 70 has a plurality of grippers 75 that are each configured to grip a spacer 50. Preferably, at least some of the grippers 75 are adjustable grippers, such that the first gripper frame 70 is configured to hold spacers 50 of different sizes, different shapes, or both. Additionally or alternatively, the first gripper frame 70 can optionally be configured to grip (e.g., simultaneously) all four legs of a rectangular spacer. FIGS. 1-16 and 18A-20C show non-limiting examples of spacers 50 that each have a rectangular configuration (i.e., where four legs of the spacer collectively delineate a rectangular shape).

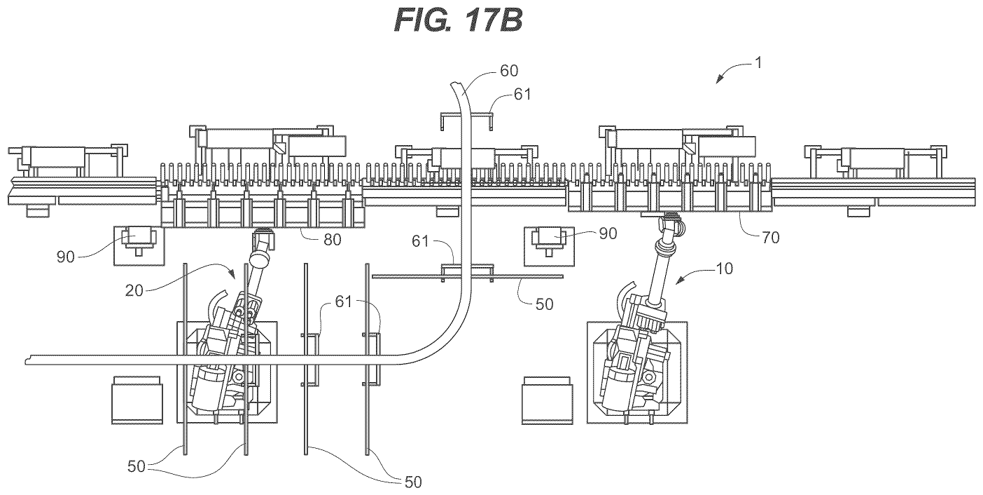

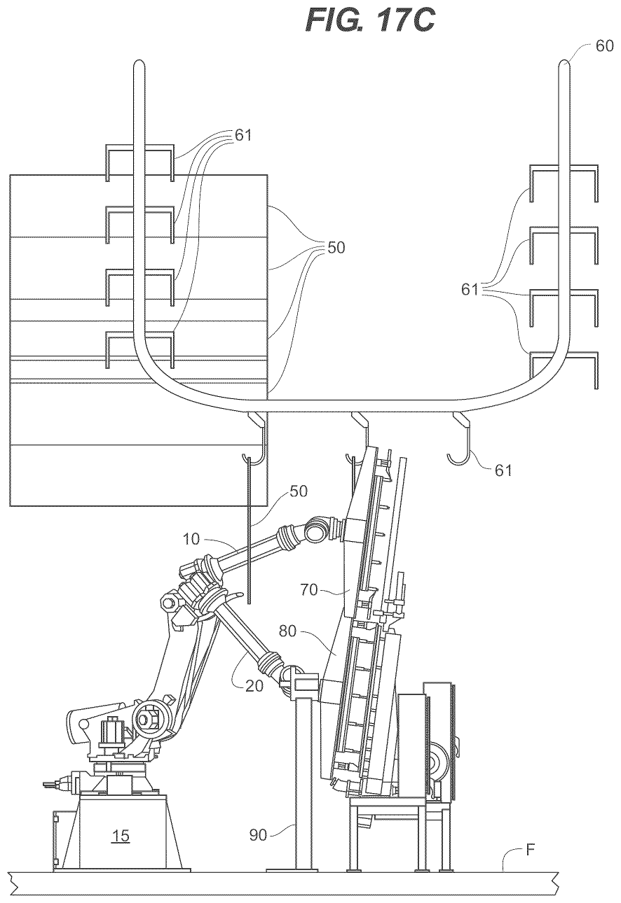

FIGS. 18-20 (i.e., FIGS. 18A, 18B, 18C, 19A, 19 B, 19C, 20A, 20B, and 20C) show one non-limiting example of a suitable configuration for the first gripper frame 70. Here, the first gripper frame 70 comprises a plurality of frame members 72. The illustrated frame members 72 are spaced apart from one another and substantially parallel to one another. The first gripper frame 70 preferably includes at least one crossbeam 77 that is crosswise (e.g., perpendicular) to a plurality of (e.g., all) the frame members 72. In the illustrated example, the working end of the first robot arm 10 is attached to the crossbeam 77 of the first gripper frame 70. This, however, is not required.

As can be appreciated by referring to FIGS. 18-20, each gripper 75 can optionally have an open position and a closed position. In such cases, each gripper 75 can be selectively opened or closed. To grip an adjacent spacer 50, a plurality of such grippers 75 can be actuated so as to move from the open position to the closed position, thereby clamping onto opposed sides of the spacer.

As illustrated, the first gripper frame 70 preferably comprises a plurality of tracks along which respective adjustable grippers 75 are movable (e.g., slidable or otherwise adjustable) to different positions. This enables handling spacers of different sizes and shapes. Preferably, at least some adjustable grippers 75 are movable along tracks extending along a height of the gripper frame, as shown in FIGS. 18-20. In addition, the gripper frame can optionally include at least one line of grippers that is moveable (e.g., slidable or otherwise adjustable) along a width of the gripper frame. As can be appreciated from FIGS. 18-20, one line of grippers 75 can optionally be adjustable along a width of the gripper. This line of grippers can be adjustable (e.g., slidably actuatable by a servo motor) along a track that is perpendicular to tracks on the frame members 72. Another option is to have this line of grippers be manually removable and replaceable at different points along the width of the gripper frame. Thus, some of the grippers 75 on the gripper frame 70 can be adjustable while others are mounted in fixed positions on the gripper frame. Given the present teaching as a guide, skilled artisans will appreciate that a variety of different gripper frame configurations can be used.

It is to be appreciated that the first robot arm 10 can be incorporated in various different embodiments of the robotic spacer processing system 1. In certain embodiments, the robotic spacer processing system 1 further includes an insulating glazing unit assembly line (or “IG line”) 30 and a spacer conveyor system 160. When provided, the insulating glazing unit assembly line 30 includes a pane conveyor line 40, while the spacer conveyor system 160 includes a spacer conveyor line 65. In such embodiments, the IG line 30 and the spacer conveyor line 65 are both adjacent the first robot arm 10.

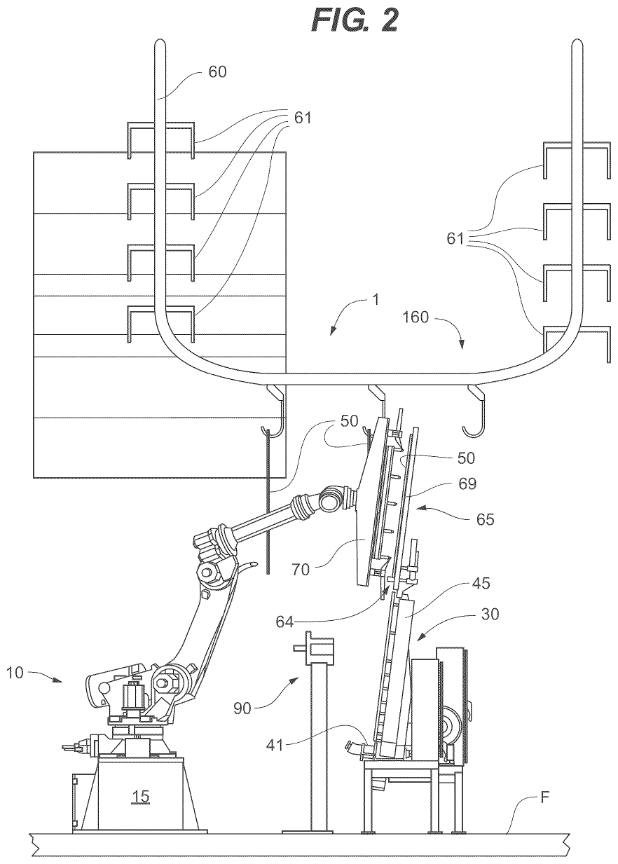

In FIGS. 1-16, the spacer conveyor line 65 is located above (e.g., at a higher elevation than, and optionally directly above) the insulating glazing unit assembly line 30. Here, the illustrated spacer conveyor line 65 has a staging area, where a spacer 50 is to be positioned for the first gripper frame 70 to pick it off the spacer conveyor line. FIGS. 1 and 2 show a spacer 50 positioned on the staging area, and thus ready to be picked up by the first gripper frame 70. The staging area of the spacer conveyor line 65 can optionally be above (e.g., directly above) a processing area of the IG line 30. In such cases, the processing area of the IG line 30 is a location where the spacer 50 is subsequently pressed against, and thereby adhered to, a pane 200 that is on the IG line 30.

While the illustrated spacer conveyor line 65 is above the IG line 30, this is not required. For example, the spacer conveyor line can alternatively be a stand-alone conveyor located behind, or extending alongside, the first robot arm. As another possibility, the spacer conveyor line 65 itself can alternatively be an overhead conveyor off which the first robot arm directly picks the spacers.

In one or more embodiments, the illustrated spacer conveyor line 65 can be omitted and replaced with a staging area (optionally a standalone staging area) configured for supporting and staging a spacer for picking therefrom by the first robot arm. When provided, such a staging area can be spaced apart from (and not supported by the same framework as) the IG line. In such embodiments, the staging area typically is not configured for conveying spacers. In certain embodiments of this nature, an additional robot (e.g., a “staging robot”) is provided and is configured to pick up a spacer (e.g., from a nearby stack or other supply) and place it on the staging area. In such cases, the first robot arm then picks the spacer off the staging area, moves it to the sealant applicator (where sealant is applied to the spacer while held by the first robot arm), and then places it on a glass sheet located on the IG line. If desired, an overhead conveyor can be provided and configured to deliver a spacer directly onto such a staging area. Thus, the staging robot can be omitted in some cases. Alternatively, an overhead conveyor can be configured to present the spacer to a staging robot, which picks the spacer off the overhead conveyor and places it on the staging area. In still other embodiments, an overhead conveyor is configured to present spacers directly to the first robot arm. Many suitable variants along these lines will be apparent to skilled artisans given the present teaching as a guide.

In certain preferred embodiments, the spacer conveyor system 160 further includes an overhead conveyor 60. With continued reference to FIGS. 1-16, the overhead conveyor 60 is located (e.g., in part, substantially entirely, or entirely) above the spacer conveyor line 65. When provided, the overhead conveyor 60 delineates a spacer path along which spacers 50 are conveyed. Part or all of the spacer path can be curved, if desired, depending on the desired overhead spacer routing.

The illustrated overhead conveyor 60 comprises a plurality of hooks 61 configured to respectively retain a plurality of spacers 50, e.g., such that the spacers hang downwardly from the hooks. In the embodiments illustrated, each of the hooks 61 comprises a pair of hook arms, and each pair of hook arms is configured to retain a spacer 50 in a hanging position therefrom. These details, however, are by no means required.

Preferably, part of the spacer path delineated by the overhead conveyor 60 intersects (e.g., passes through) the spacer conveyor line 65. In such cases, at least a certain length of the spacer path is crosswise to (e.g., so as to pass through, in crosswise manner) the spacer conveyor line 65. This can allow spacers 50 conveyed along the spacer path to automatically drop down onto the spacer conveyor line 65. In more detail, a spacer 50 conveyed by the overhead conveyor 60 will reach a region of intersection with the spacer conveyor line 65, and upon reaching that intersection region, the spacer will contact spaced-apart upright members 69 of the spacer conveyor line. Preferably, the upright members 69 comprise generally vertical rollers, which may be offset from true vertical by a few degrees (e.g., about 3-7 degrees). As the hook 61 of the overhead conveyor 60 moves through and past the spacer conveyor line 65, the spacer 50 will be caught on the noted upright members 69 and thus pulled off the hook 61, thereby causing the spacer to fall onto the spacer conveyor line.

In embodiments where a separate staging area is provided, an overhead conveyor can be configured to intersect (e.g., pass through) the staging area in the same manner as noted above for the spacer conveyor line 65 shown in FIGS. 1-16. Thus, an overhead conveyor can be provided and configured to deliver a spacer directly onto the staging area. In such cases, the staging robot can be omitted.

Thus, in certain preferred embodiments, the spacer conveyor line 65 has a transfer region that is configured to receive spacers 50 transferred (e.g., dropped) from the overhead conveyor 60. As noted above, the transfer region of the spacer conveyor line 65 can optionally be located at a region of intersection of the overhead conveyor 60 and the spacer conveyor line 65.

The transfer region of the spacer conveyor line 65 can optionally be upstream of a spacer staging area. In the embodiment of FIGS. 1-16, the transfer region is located upstream of, and next to, the spacer staging area. In embodiments of this nature, once a spacer 50 is transferred from the overhead conveyor 60 onto the transfer region of the spacer conveyor line 65, the spacer is conveyed (e.g., in a horizontal direction) along the spacer conveyor line 65 to the spacer staging area.

The spacer conveyor line 65 preferably includes a bottom conveyor 64 configured to support a bottom side of the spacer 50. The bottom conveyor can comprise, for example, a series of spaced-apart transport rollers, at least some of which are powered. Additionally or alternatively, the bottom conveyor can comprise one or more conveyor belts. Another possibility is to have the bottom conveyor slightly inclined in the direction of the spacer staging area, such that a spacer on the bottom conveyor moves under the force of gravity along the bottom conveyor to the spacer staging area. In such cases, there may be a stop (such as an adjustably-positionable stop) to bring the spacer to rest at a desired position on the spacer staging area.

When provided, the IG line 30 is configured to convey a stream of panes (e.g., glass panes) 200 along the pane conveyor line 40. The IG line 30 preferably is configured to convey panes 200 along the pane conveyor line 40 while retaining them in an upright (e.g., generally vertical) orientation. This can be appreciated, for example, in FIGS. 1-16.

The pane conveyor line 40 preferably includes an upright conveyor wall 45. The illustrated conveyor wall 45 is configured to maintain panes 200 in a vertical-offset orientation while conveying them along the pane conveyor line 40. The vertical-offset orientation is characterized by the panes 200 being offset from true vertical by less than 10 degrees, such as about 3-7 degrees. The upright conveyor wall 45 can comprise a platen or frame. Preferably, it includes a plurality of rollers, rotatable discs or spheres, casters, or the like along which the rear sides of the panes 200 can readily roll or slide when the panes are conveyed along the pane conveyor line 40. Additionally or alternatively, the upright conveyor wall 45 can provide an air cushion.

The illustrated pane conveyor line 40 also includes a bottom conveyor 41, which preferably is configured to support a bottom edge of each pane 200 being conveyed along the pane conveyor line. Thus, a pane 200 conveyed along the pane conveyor line 40 preferably has a bottom edge supported by the bottom conveyor 41 and a rear side (e.g., a rear major surface) supported by the upright conveyor wall 45.

The panes 200 preferably are monolithic sheets of glass (or “lites”). It is to be appreciated, however, that the present systems and methods can alternatively use other types of substrates, such as polymer (e.g., polycarbonate) sheets. In some cases, the pane conveyor line 40 extends toward (e.g., is located upstream of) an automated station configured to deliver thermally insulative gas (e.g., a mix of argon and air) into the between-pane space(s) of the IG units being produced.

Thus, the illustrated pane conveyor line 40 defines a path of pane travel, which preferably extends in a horizontal (or at least substantially horizontal) direction. As noted above, the pane conveyor line 40 (e.g., a bottom conveyor 41 thereof) may include a plurality of transport rollers and/or a plurality of conveyor belts.

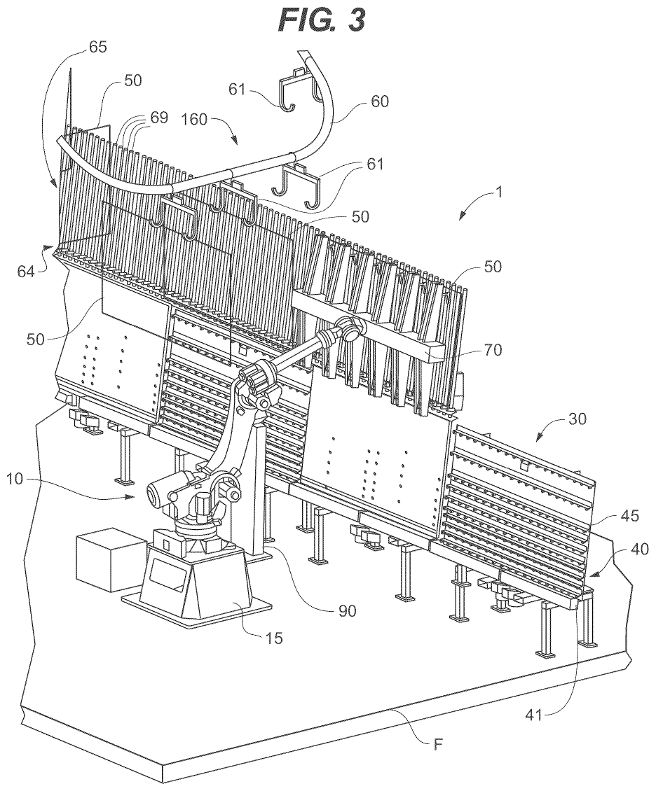

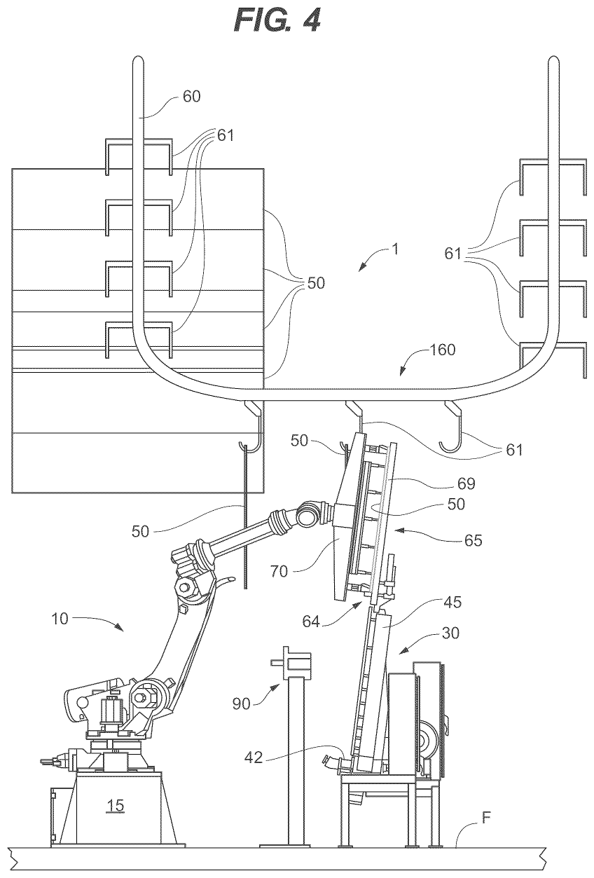

In the present embodiments, the robotic spacer processing system 1 has first and second positions. The robotic spacer processing system 1 when in the first position has the first gripper frame 70 holding a spacer 50 adjacent the spacer conveyor line 65. Reference is made to FIGS. 3 and 4. Here, the first robot arm 10 has the first gripper frame 70 in an elevated orientation (e.g., above the IG line) when the system 1 is in the first position. This, however, is not required. For example, the spacer conveyor line can alternatively be at the same level as, or a lower level than, the IG line.

In alternate embodiments where a separate (e.g., standalone) staging area is provided, the first position of the robotic spacer processing system can involve the first gripper frame holding a spacer adjacent the staging area.

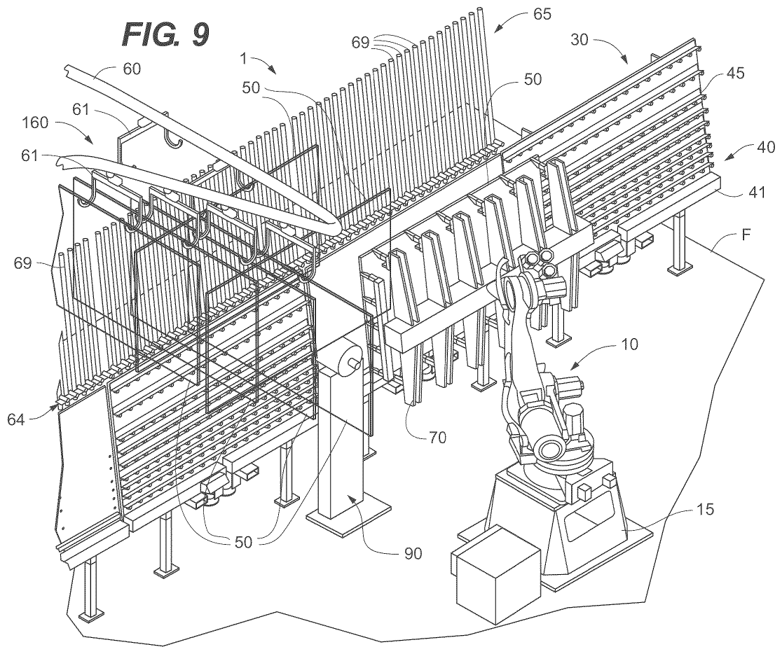

The robotic spacer processing system 1 when in the second position has the first gripper frame 70 holding the spacer 50 adjacent the insulating glazing unit assembly line 30. Reference is made to FIGS. 9-12. Here, the first robot arm 10 holds the first gripper frame 70 in a lowered orientation (e.g., relative to the elevated orientation noted above) when the system 1 is in the first position. However, this is not required either. When in the second position, the system 1 is configured to press the spacer 50 against (and thereby adhere the spacer to) a pane 200 on the IG line 30.

Preferably, the robotic spacer processing system 1 also has a start position, and when in the start position, the first robot arm 10 is configured to remove the spacer 50 from the spacer conveyor line 65 and thereafter rotate the spacer about multiple axes. Reference is made to FIGS. 1 and 2. As will be appreciated, the system 1 will be in the start position before moving to the first position. When in the start position, a plurality of activated grippers 75 on the first gripper frame 70 preferably are in an open position, so as to be ready to grip a spacer 50 on the spacer conveyor line 65.

In alternate embodiments where a separate (e.g., standalone) staging area is provided, the start position of the robotic spacer processing system can involve the first robot arm being configured to remove a spacer from the staging area.

As noted above, the first robot arm 10 having the first gripper frame 70 can be incorporated into various different embodiments of the robotic spacer processing system 1. In some embodiments, the system 1 also includes a sealant applicator 90. When provided, the sealant applicator 90 is located adjacent the first robot arm 10. In such embodiments, the first robot arm 10 with the first gripper frame 70 is configured to hold a spacer 50 at the sealant applicator 90. This is a sealing position, and/or an intermediate position, of the robotic spacer processing system 1. Thus, the system 1 when in the sealing position has the first gripper frame 70 holding the spacer 50 at the sealant applicator 90.

When the system 1 is in the sealing position, the sealant applicator 90 is configured to apply sealant along at least one side (preferably along opposed sides) of the spacer 50 held by the first gripper frame 70. The applied sealant preferably is a bead of sealant extending along a length (preferably extending continuously along the entire length) of the spacer 50. In more detail, the first robot arm 10 preferably is configured to move the spacer 50 along a nozzle of the sealant applicator station 90, so as to apply a bead of sealant along a length of the spacer. In cases where the spacer is rectangular, the bead preferably is applied along all four legs of the spacer.

In the embodiments illustrated, the sealant applicator 90 is a standalone station that is spaced apart from IG line 30. The sealant applicator 90 preferably includes (e.g., is adapted to dispense) a supply of sealant, such as PIB or another suitable primary sealant material.

In certain embodiments involving a sealant applicator, the system is simply configured to process spacers through the sealant applicator, i.e., so as to apply sealant to them, without using the robot arm to subsequently apply the spacer to a pane.

In other embodiments, the robotic spacer processing system 1 further includes an insulating glazing unit assembly line 30 and a spacer conveyor system 160. In such cases, the sealant applicator 90 is located adjacent both the IG line 30 and the spacer conveyor system 160, in addition to being located adjacent the first robot arm 10. In embodiments of this nature, the sealant applicator 90 preferably is a standalone station (e.g., a PIB pedestal) that is spaced apart from IG line 30, the spacer conveyor system 160, and the first robot arm 10.

In the present embodiments, the first robot arm 10 with the first gripper frame 70 is configured to remove a spacer 50 from the spacer conveyor line 65, move that spacer to the sealant applicator 90 where sealant is applied to the spacer, then move the resulting sealant-bearing spacer to the IG line 30, and press the spacer against a pane 200 on the IG line. In doing so, sealant on the spacer adheres to the pane, thus securing the spacer to the pane. Reference is made to FIGS. 1-14.

Thus, in certain preferred embodiments, the robotic spacer processing system 1 includes the first robot arm 10, an insulating glazing unit assembly line 30, a spacer conveyor system 160, and a sealant applicator 90. This is exemplified by the non-limiting embodiment shown in FIGS. 1-16.

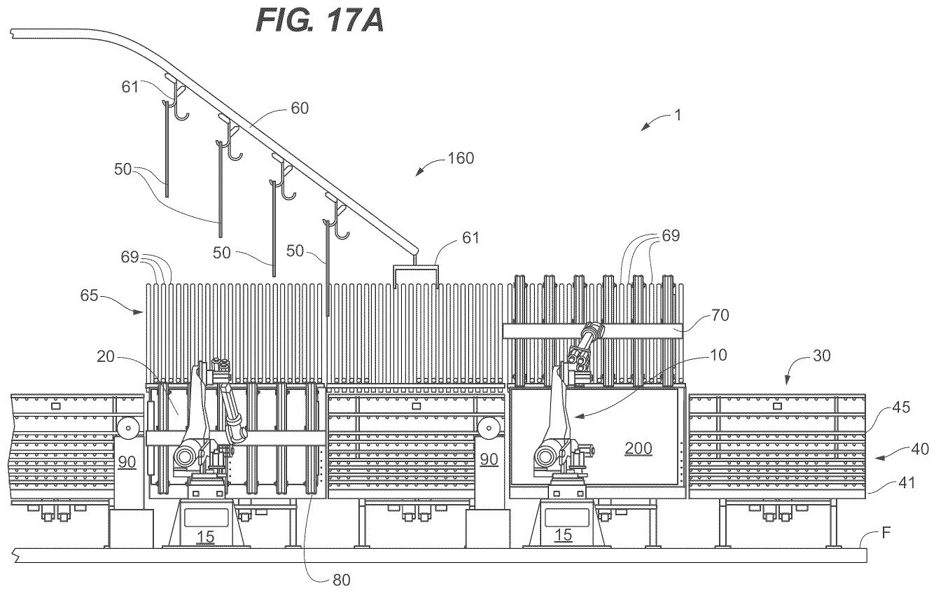

Furthermore, some embodiments provide first 10 and second 20 robot arms respectively having first 70 and second 80 gripper frames. Reference is made to FIGS. 17A, 17B, and 17C. In the present embodiments, each of the two robot arms 10, 20 can optionally be of the nature described above. For example, they can each have multiple axes of rotation, i.e., each can be a multi-axis robot arm. Preferably, each such robot arm has four or more (e.g., six) axes of rotation. Thus, the first 10 and second 20 robot arms in the present embodiments can each be of the nature described above for the first robot arm (e.g., for features described above as being for the “first robot arm,” each such description should be understood to be copied, modified by referring instead to the “second robot arm,” and incorporated as part of the present paragraph). The same is true of the previous descriptions of the first gripper frame 70 relative to the second gripper frame 80. In some cases, both robot arms 10, 20 are the same robot model, such as model number R2000iC/165 from Fanuc. In other cases, the two robot arms are different robot models. Furthermore, the gripper frames 70, 80 on the two robot arms 10, 20 can be the same or different. When two robot arms are provided, they typically will be the same robot models and will carry the same types of gripper frames. This, however, is not required.

Thus, FIGS. 17A, 17B, and 17C show a non-limiting example of a robotic spacer processing system 1 that includes first 10 and second 20 robot arms. As best seen in FIGS. 17A and 17B, the first 10 and second 20 robot arms are positioned at spaced apart locations alongside the IG line 30. Here, both robot arms 10, 20 are on the same side of the IG line.

In the illustrated embodiment, the system 1 also has a spacer conveyor system 160 comprising a spacer conveyor line 65 and an optional overhead conveyor 60. If desired, the overhead conveyor can be omitted, and the spacers can simply be conveyed along a modified version of the illustrated spacer conveyor line. In such cases, the modified spacer conveyor line itself can be configured to bring spacers to the working area. Alternative arrangements of this nature can be provided whether the system has one or two robot arms.

In the embodiment illustrated, the overhead conveyor 60 delineates a spacer path that passes in a crosswise (e.g., substantially perpendicular) manner through the spacer conveyor line 65. The nature of such an intersection has already been described with respect to FIGS. 1-16. That prior description also applies to the present intersection, which is shown in FIGS. 17A, 17B, and 17C. As is perhaps best seen in FIG. 17B, the two robots 10, 20 are located on opposite sides of a desired length (e.g., a delivery section) of the illustrated overhead conveyor 60. This, however, is by no means required.

In more detail, the illustrated spacer conveyor line 65 has a transfer region located between (e.g., directly between) first and second staging areas. The first 10 and second 20 robot arms are respectively located adjacent the first and second staging areas of the spacer conveyor line 65. Thus, when the system 1 is in a first start position, the first robot arm 10 has the first gripper frame 70 adjacent a spacer 50 on the first staging area of the spacer conveyor line 65. With the system 1 in this position, the first robot arm 10 is ready to pick (e.g., has a plurality of grippers in an open position) the adjacent spacer 50 off the spacer conveyor line 65. Further, when the system 1 is in a second start position, the second robot arm 20 has the second gripper frame 80 adjacent a spacer 50 on the second staging area of the spacer conveyor line 65. With the system 1 in this position, the second robot arm 20 is ready to pick (e.g., has a plurality of grippers in an open position) the adjacent spacer 50 off the spacer conveyor line 65.

Subsequently, when the system 1 is in a first pressing position, the first robot arm 10 has the first gripper frame 70 holding a spacer 50 adjacent a pane 200 on the IG line 30. With the system 1 in this position, the first robot arm 10 is ready to press the spacer 50 held by the first gripper frame 70 against the adjacent pane 200 on the IG line 30. When that spacer 50 is then pressed against the pane 200, sealant on the spacer adheres it to the pane.

Similarly, when the system 1 is in a second pressing position, the second robot arm 20 has the second gripper frame 80 holding a spacer 50 adjacent a pane 200 on the IG line 30. With the system 1 in this position, the second robot arm 20 is ready to press the spacer 50 held by the second gripper frame 80 against the adjacent pane 200 on the IG line 30. When that spacer 50 is then pressed against the pane 200, sealant on the spacer adheres it to the pane.

As will be appreciated, the system 1 will be in the first start position before moving to the first pressing position. When in the first start position, a plurality of activated grippers 75 on the first gripper frame 70 preferably are in an open position, so as to be ready to grip the adjacent spacer 50 on the spacer conveyor line 65. Likewise, the system 1 will be in the second start position before moving to the second pressing position. When in the second start position, a plurality of activated grippers on the second gripper frame 80 preferably are in an open position, so as to be ready to grip the adjacent spacer 50 on the spacer conveyor line 65.

Furthermore, in the embodiment shown in FIGS. 17A, 17B, and 17C, the system 1 includes two sealant applicators 90. One of the sealant applicators 90 is adjacent (e.g., positioned for use by) the first robot arm 10, and the other sealant applicator 90 is adjacent (e.g., positioned for use by) the second robot arm 20.

In the embodiment illustrated, the two sealant applicators 90 are located on opposite sides of a section (delivery section) of the overhead conveyor 60. This is best shown in the top view of FIG. 17B. It is to be appreciated, however, that this is not required; the sealant applicators can be provided at various different locations.

In FIGS. 17A, 17B, and 17C, the illustrated sealant applicators 90 are standalone applicators (e.g., PIB pedestals), which are spaced apart from the IG line 30. These details, however, are not required.

In the embodiment shown in FIGS. 17A, 17B, and 17C, the system 1 has a first intermediate position (or “first sealing position”) characterized by the first gripper frame 70 holding a spacer 50 adjacent a first sealant applicator 90. When the system 1 is in the first sealing position, the first sealant applicator 90 is configured to apply sealant along at least one side (preferably along opposed sides) of the spacer 50 held by the first gripper frame 70.

With continued reference to FIGS. 17A, 17B, and 17C, the illustrated system 1 also has a second intermediate position (or “second sealing position”), which is characterized by the second gripper frame 80 holding a spacer 50 adjacent a second sealant applicator 90. When the system 1 is in the second sealing position, the second sealant applicator 90 is configured to apply sealant along at least one side (preferably along opposed sides) of the spacer 50 held by the second gripper frame 80.

As will be appreciated, the illustrated system 1 will be in the first sealing position after moving from the first start position and before moving to the first pressing position. Likewise, the illustrated system 1 will be in the second sealing position after moving from the second start position and before moving to the second pressing position.

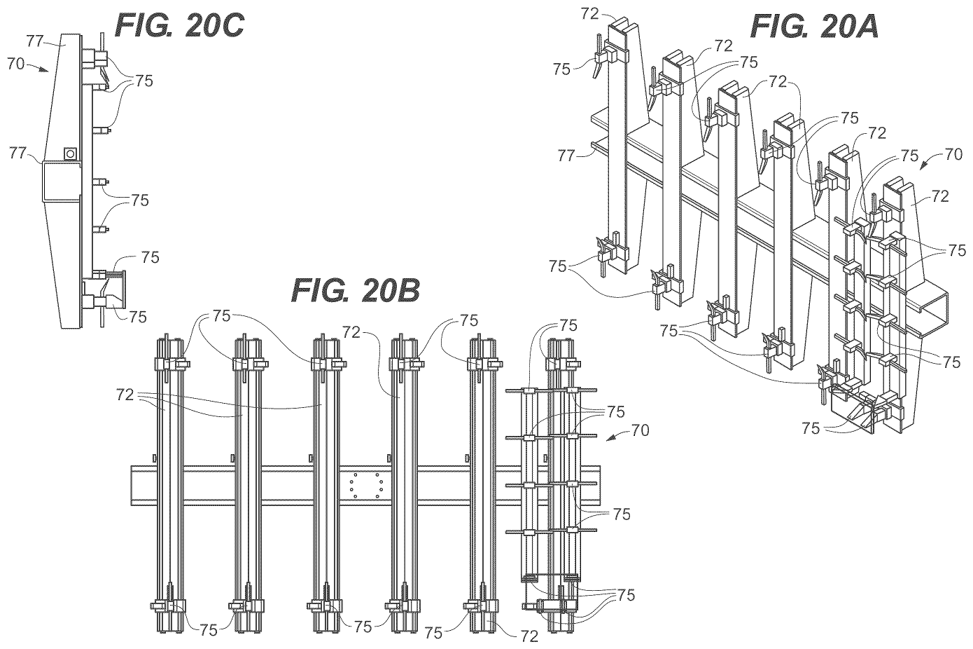

Thus, as can be appreciated from FIGS. 1-16, the invention provides embodiments involving a method of operating a robotic spacer processing system 1 comprising an insulating glazing unit assembly line 30, a spacer conveyor system 65, a sealant applicator 90 or 90′, and a first robot arm 10. The first robot arm 10 is equipped with a first gripper frame 70. The robotic spacer processing system 1 has an intermediate position, such that the system when in the intermediate position has the first gripper frame 70 holding a spacer 50 adjacent the sealant applicator 90 or 90′. Moreover, the system 1 when in the intermediate position is configured to apply sealant onto opposed sides of the spacer 50. In the present embodiments, the method includes applying sealant onto the spacer 50 by operating the first robot arm 70 to move the spacer along a nozzle of the sealant applicator so as to apply the sealant along all legs of the spacer while the first robot arm maintains the spacer in an upright rotationally-fixed position. Reference is made to the embodiments of FIGS. 1-16. Other embodiments of this nature can be appreciated by referring to FIGS. 22-25.

In some cases, the spacer 50 is a rectangular spacer having four legs, and the application of sealant by operating the first robot arm 70 to move the spacer along the nozzle of the sealant applicator 90 or 90′ is performed so as to apply the sealant along all four legs of the rectangular spacer while the first robot arm maintains the spacer in an upright rotationally-fixed position. Non-limiting examples of a rectangular spacer are shown in FIGS. 1-16, 17C, 18A, 18B, 19A, 19B and 22-25. It will be appreciated, of course, that rectangular spacers of various sizes and different rectangular shapes can be used. Moreover, although the spacers are rectangular in many cases (e.g., when making rectangular IG units), the present methods can be carried out with spacers of many different shapes, including triangular and various other polygonal shapes. Thus, the present invention is not limited to any particular spacer shape.

In the present methods, the sealant preferably is applied to extend continuously along an entire length of the spacer. The present methods and systems can involve a variety of different spacer types. FIG. 21 shows several non-limiting examples of spacer types that can be used.

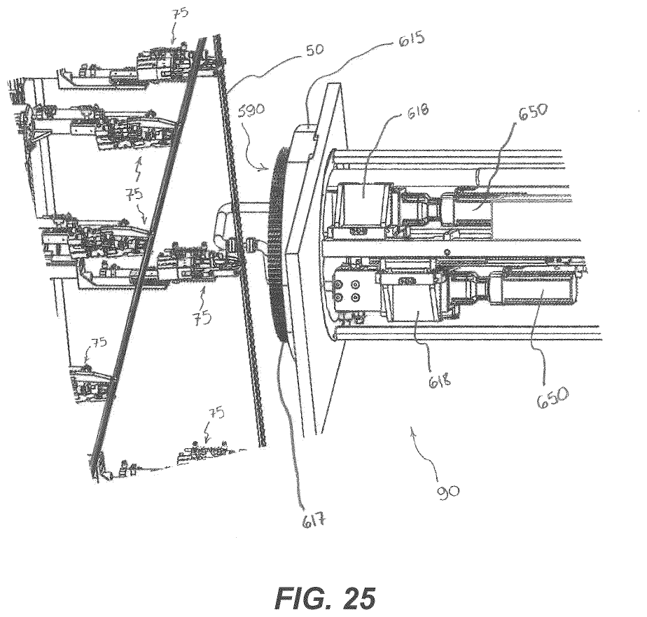

As noted above, the first robot arm 10 preferably has a mount base 15 that is mounted to a floor. Furthermore, the first robot arm 10 preferably is an articulated robot having multiple rotary joints that provide multiple axes of rotation. In such cases, the articulated robot preferably has a single robot arm (i.e., only one robot arm, which is the first robot arm), and the first robot arm preferably is equipped with a single gripper frame (i.e., only one gripper frame, which is the first gripper frame). In more detail, the first robot arm 10 preferably has four or more (e.g., six) axes of rotation, and the first robot arm preferably has a mount base 15 that is mounted (or is configured to be mounted) in a fixed position on the floor. This is the case for the systems shown in FIGS. 1-16, 22-25, and 28.

In certain embodiments, the robotic spacer processing system 1 further includes a second robot arm 20. In embodiments of this nature, the first 10 and second 20 robot arms preferably are positioned at spaced apart locations, alongside the insulating glazing unit assembly line 30, e.g., such that both the first and second robot arms are on the same side of the insulating glazing unit assembly line. Furthermore, the first robot arm 10 preferably has a mount base 15 that is mounted to the floor (e.g., at a fixed position), and when provided, the second robot arm 20 may likewise have a mount base 15 that is mounted to the floor (e.g., at a fixed position). In such embodiments, the mount base 15 of the second robot arm 20 preferably is spaced apart from the mount base 15 of the first robot arm 10.

Further, some embodiments of the robotic spacer processing system 1 include a second sealant applicator 90 or 90′, preferably such that the two sealant applicators are spaced apart from each other along a downstream direction of the IG unit assembly line 30. In embodiments of this nature, the first sealant applicator 90 or 90′ can be positioned for use by (e.g., operably coupled with) a first robot arm 10, while the second sealant applicator 90 or 90′ is positioned for use by (e.g., operably coupled with) the second robot arm 20. Moreover, the first 10 and second 20 robot arms can respectively have first and second mount bases 15 that are mounted to a floor at locations spaced apart alongside the IG unit assembly line 30. As noted above, the sealant applicator(s) 90 or 90′ preferably include a supply of PIB. Alternatively, the present methods and systems can be used to apply other sealant materials.

Preferably, the spacer conveyor system includes a spacer conveyor line 65 above the IG unit assembly line 30. In other cases, the system includes a spacer conveyor line provided at various other locations. Regardless of the specific location of the spacer conveyor line, when provided, it preferably is within an operable range (i.e., within reach) of the first robot arm. In addition, the IG unit assembly line 30 preferably is within the operable range (i.e., within reach) of the first robot arm. This can optionally be the case for any embodiment of the present disclosure. It is to be appreciated, however, that for some embodiments, the spacer conveyor line is omitted.

As discussed previously, the IG unit assembly line 30 comprises a pane conveyor line 40, and the method preferably includes conveying a stream of panes along the pane conveyor line. In the embodiments illustrated, the pane conveyor line 40 includes an upright conveyor wall 45 configured to maintain the panes in a vertical-offset orientation during their conveyance along the pane conveyor line. Preferably, the upright conveyor wall 45 comprises a platen and/or frame, optionally equipped with rollers, wheels, casters, or an air cushion configured to facilitate moving the panes along the conveyor wall.

When provided, the spacer conveyor line 65 can optionally be directly above the IG unit assembly line 30. Additionally or alternatively, the spacer conveyor line 65 can include spaced-apart upright members 69, which can optionally comprise generally vertical rollers. This optional feature is shown in a number of the drawings.

More generally, the spacer conveyor line 65 preferably has an elongated assembly line structure. In addition, the IG unit assembly line 30 preferably has an elongated assembly line structure. In embodiments of this nature, the spacer conveyor line 65 can advantageously extend along above a top region of the IG unit assembly line 30, such that the elongated assembly line structure of the spacer conveyor line is generally parallel to the elongated assembly line structure of the IG unit assembly line. Non-limiting examples are shown in FIGS. 1, 3, 5, 7, 9, 11, 13, 17A, 27, and 28. As noted above, for some embodiments, the spacer conveyor line is omitted.

In the present embodiments, the method preferably includes conveying a spacer 50 along the spacer conveyor line 65 in a desired downstream direction, and conveying a glass pane along the insulating glazing unit assembly line 30 in a downstream direction that is generally parallel to the above-noted desired downstream direction.

Furthermore, with reference to the non-limiting examples of FIGS. 17A, 17B, 27, and 28, the spacer conveyor line 65 can optionally be configured to selectively move a first spacer along the spacer conveyor line in the desired downstream direction while also being configured to thereafter move a second spacer along the conveyor line in an opposite direction (e.g., an upstream direction). Certain related methods include sequentially moving such first and second spacers along the conveyor line in this manner. In embodiments of this nature, a series of spacers delivered (such as from an optional overhead spacer conveyor) onto the spacer conveyor line 65 can, in an alternating sequence, be delivered to a downstream position (for picking by the first robot arm) and an upstream position (for picking by a second robot arm). It is to be appreciated, however, that this is by no means required. For example, other embodiments of the system have just one robot arm 10. Moreover, in some embodiments, the spacer conveyor line is omitted.

Preferably, the spacer conveyor line 65 has a bottom conveyor configured to support a bottom of the spacer 50. Similarly, the IG unit assembly line 30 preferably has a bottom conveyor configured to support a bottom edge of each pane conveyed along the IG unit assembly line. In embodiments of this nature, the nozzle of the sealant applicator 90 or 90′ preferably is at a higher elevation than the bottom conveyor of the IG unit assembly line 30, and the bottom conveyor of the spacer conveyor line 65 preferably is at a higher elevation than the nozzle of the sealant applicator. As described previously, the bottom conveyor of the spacer conveyor line 65 preferably comprises transport rollers and/or one or more conveyor belts. Similarly, the bottom conveyor of the IG unit assembly line 30 preferably comprises transport rollers and/or one or more conveyor belts.

The present disclosure includes a group of embodiments involving a sealant applicator with two confronting nozzles configured to rotate (e.g., being rotatable) about a sealant-application zone between the two nozzles. The sealant applicator is configured to apply sealant onto two opposed sides of a spacer. Some embodiments of the present group provide a sealant applicator of this type (whether alone or in combination with other equipment), others provide a method of operating such an applicator to apply sealant onto a spacer (e.g., in synchronized cooperation with a robot arm holding the spacer), and still others provide a robotic spacer processing system that includes a sealant applicator of this nature in combination with a robot arm. Thus, some embodiments provide a robotic spacer processing system that includes a sealant applicator in combination with a robot arm, with the sealant applicator optionally being integrated into an IG unit assembly line of the system. Related method embodiments involve operating a system of this nature.

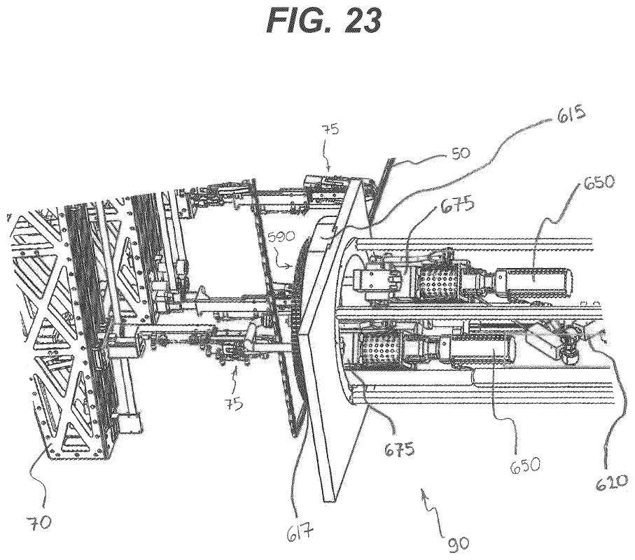

As noted above, in the present embodiments, the sealant applicator 90 or 90′ comprises two confronting nozzles 190 having a sealant-application zone between them. In the non-limiting example of FIG. 26, a spacer 50 is shown in the sealant-application zone between the two nozzles 190. Some embodiments provide a method that includes operating the robot arm 10 so as to move the spacer 50 through the sealant-application zone while operating the two confronting nozzles 190 to apply sealant onto two opposed sides of the spacer. Reference is made to FIGS. 22-25.

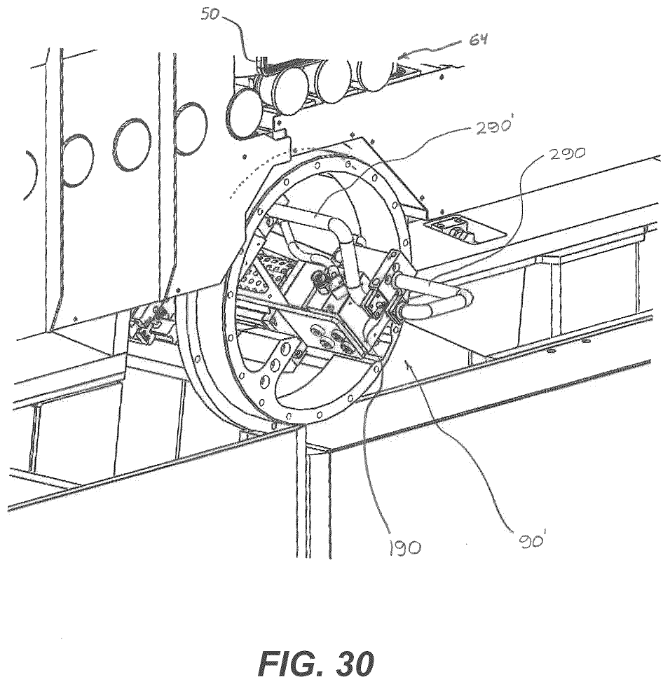

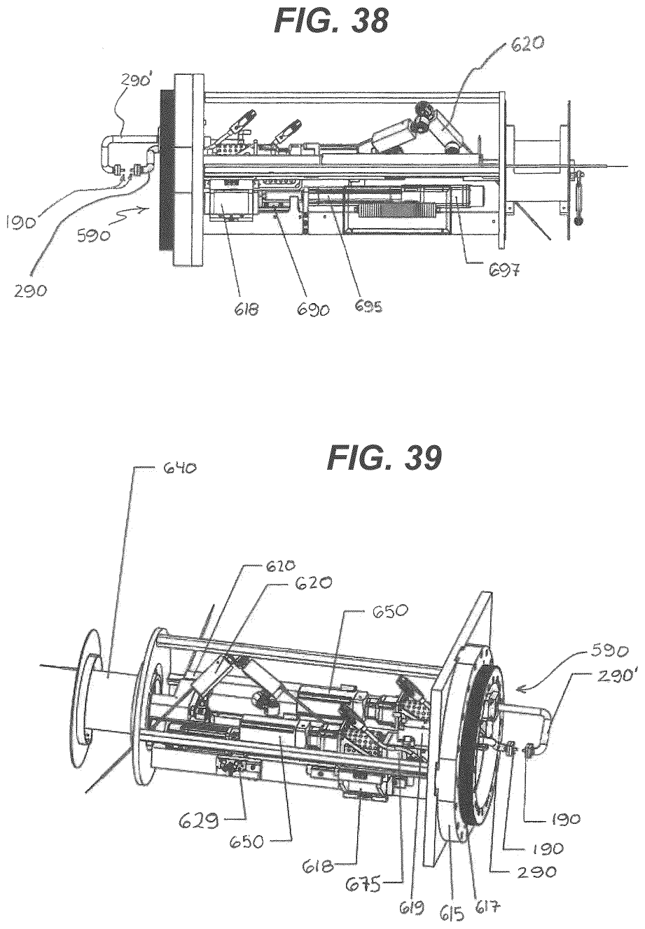

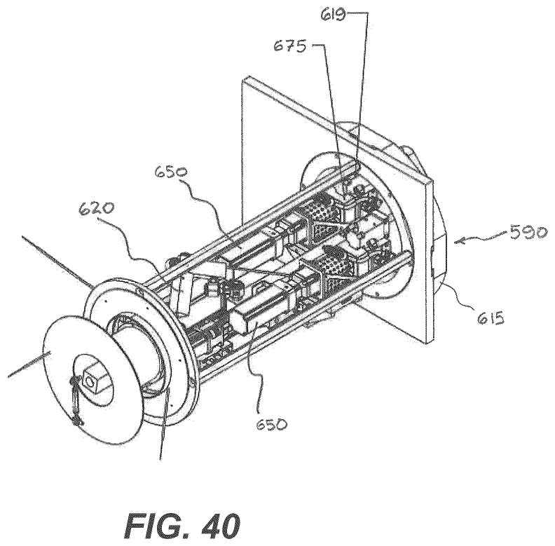

Preferably, the sealant applicator 90 or 90′ comprises a dispenser head 590, and when the spacer 50 is moved through the sealant-application zone, a first of the two opposed sides of the spacer faces toward the dispenser head, while a second of the two opposed sides of the spacer faces away from the dispenser head. This is perhaps best appreciated by referring to FIG. 26 in view of FIGS. 22-55. In such cases, a first of the two confronting nozzles 190 is positioned to apply (e.g., applies) sealant onto the first of the two opposed sides of the spacer 50, while a second of the two confronting nozzles is positioned to apply (e.g., applies) sealant onto the second of the two opposed sides of the spacer. With two confronting nozzles 190 of this nature, sealant can be simultaneously applied onto both opposed sides of the spacer 50.

In the non-limiting examples of FIGS. 22-33, both nozzles 190 are configured to dispense sealant (therefrom, onto a spacer 50) in a horizontal or generally horizontal (e.g., at least substantially horizontal) direction. While this can optionally be the case for any embodiment of the present disclosure, it is not required.

In certain embodiments, one of the two confronting nozzles 190 is moveable selectively toward or away (e.g., directly toward or away) from the other. For example, the first nozzle 190 can be configured to be adjusted by moving selectively toward or away from the second nozzle 190. This can be linear (e.g., axial) movement in a horizontal or generally horizontal direction. This optional adjustability feature can facilitate using spacers of different widths and/or help with retracting such nozzle away from the spacer.

Thus, the sealant applicator 90 or 90′ comprises two confronting nozzles 190, which preferably are disposed respectively on two sealant-delivery tubes 290, 290′ (or other rigid plumbing structure) projecting away from (e.g., in a cantilevered manner) the dispenser head 590. Furthermore, the sealant applicator 90 or 90′ includes a supply of PIB (or another desired sealant material) configured to provide PIB (or other sealant material) to the two confronting nozzles 190 via the two sealant-delivery tubes 290, 290′. Thus, the dispenser head 590 preferably includes sealant plumbing that is in communication with one or more sealant supplies and the two sealant-delivery tubes 290, 290′.

Preferably, the dispenser head is equipped with one or more sealant pumps, with each pump including a pump motor. In some cases, the sealant applicator includes two sealant pumps (e.g., one sealant pump for tube 290, another sealant pump for tube 290′), each including a pump motor, such that the dispenser head includes two pump motors.

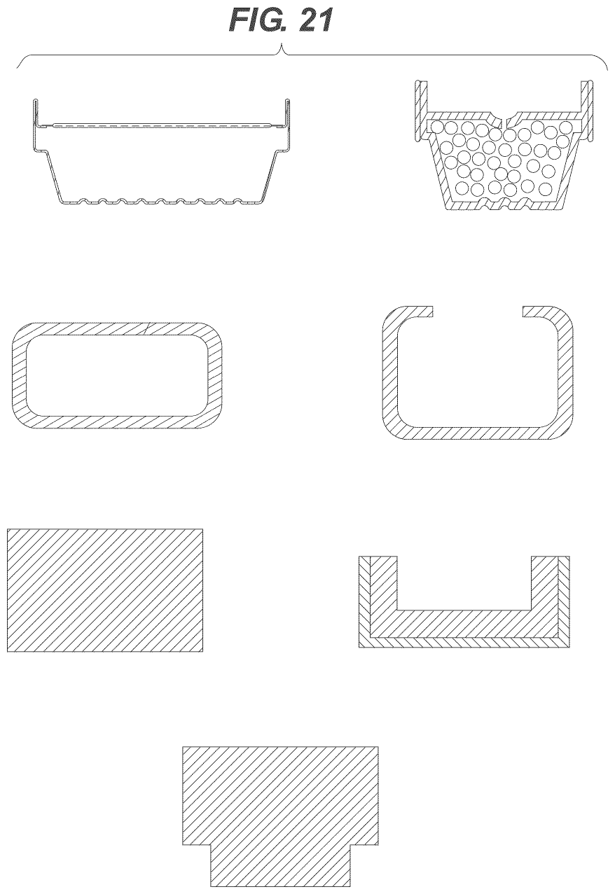

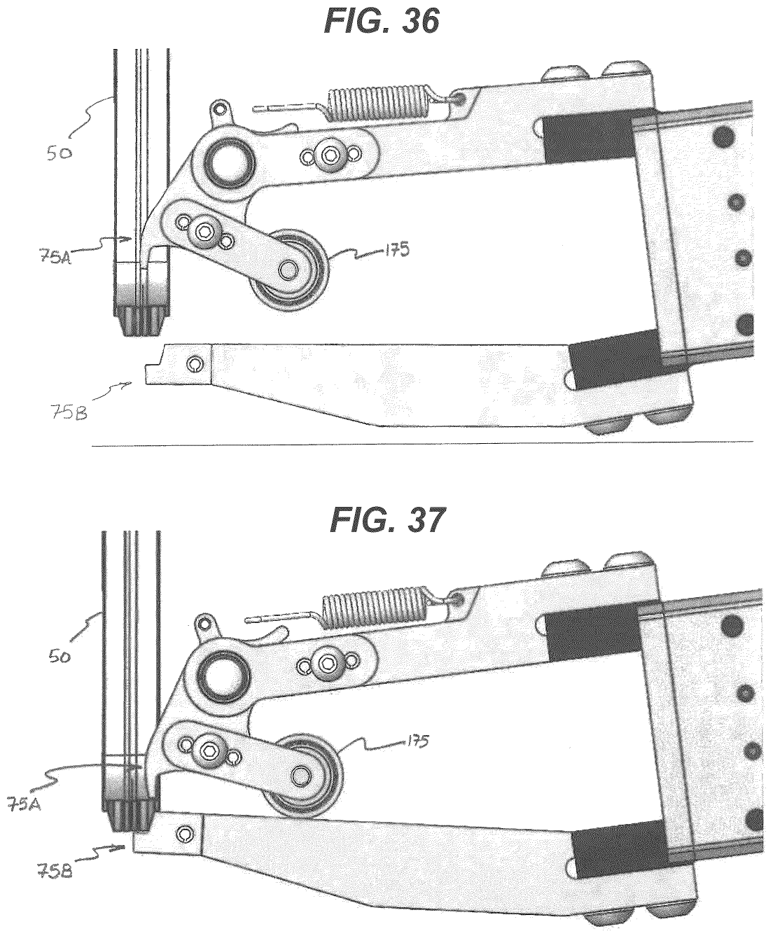

FIGS. 22-25 show an embodiment of the sealant applicator 90 or 90′ comprising a dispenser head 590 that has a generally cylindrical configuration. Furthermore, FIGS. 38-40 provide additional side and perspective views of the dispenser head 590 of FIGS. 22-25. Here, the illustrated dispenser head 590 comprises a generally cylindrical framework, cage, and/or housing. As is perhaps best seen in FIG. 23, two pump motors are indicated by reference number 650, and two pumps are indicated by reference number 675. Reference number 615 identifies a bearing support, and reference number 617 identifies a nozzle rotation drive pulley. Reference number 620 identifies sealant supply plumbing. Reference number 618 identifies pump mounting and alignment brackets. Reference number 619 identifies pump snuff back valves, and reference number 629 identifies a valve for snuff back valve actuation. Reference number 640 identifies cat track void for electrical and pneumatic lines. Reference number 697 identifies a nozzle height adjustment motor, reference number 695 identifies a nozzle height adjustment actuator, and reference number 690 identifies a nozzle height adjustment linear bearing rail.

It is to be appreciated that the details shown in FIGS. 22-25 and 38-40 are not required. As just one example, it is not necessary that either nozzle 190 be adjustable selectively toward or away from the other nozzle 190. When provided, such nozzle adjustability can be referred to as “height adjustability.” Thus, in the non-limiting example shown here, the first nozzle (or “nozzle 1,” which is at the end of first sealant-delivery tube 290) is height adjustable. This is representative of embodiments wherein at least one of the two nozzles 190 is height adjustable. This feature can optionally be included for any embodiment involving the two confronting nozzles 190 disclosed herein.

As noted above, the two confronting nozzles 190 of the sealant applicator 90 or 90′ are rotatable about the sealant-application zone. For example, the sealant applicator 90 or 90′ preferably is configured (and operated) such that when the sealant applicator applies sealant to a corner of the spacer 50, the two confronting nozzles 190 rotate about the sealant-application zone. Thus, some related method embodiments include rotating the two confronting nozzles 190 about the sealant-application zone while operating the sealant applicator 90 or 90′ to apply sealant to a corner of the spacer 50.

Furthermore, the sealant applicator 90 or 90′ can optionally be configured such that the sealant-application zone does not move linearly (or at least not substantially), but rather remains in a fixed (or at least substantially fixed) location, at all times during operation of the sealant applicator. In the non-limiting example of FIGS. 22-25, the sealant-application zone can optionally remain at a location that is fixed (or at least substantially fixed) relative to the dispenser head 590 at all times when applying sealant along each/all of the legs of the spacer. In such cases, the rotational orientation of the two nozzles 190 and the sealant-delivery tubes 290, 290′ will be different based on which leg of the spacer sealant is being applied to, and this rotational orientation changes when sealant is applied about each corner of the spacer. This can be appreciated by referring to FIGS. 22-25 and 29-32.

The present method includes rotating the two confronting nozzles 190 about the sealant-application zone. Preferably, this rotation is performed each time the robot arm 10 moves a corner of the spacer 50 through the sealant-application zone, i.e., each time the robot arm turns a corner of the spacer while the sealant applicator is applying sealant onto the spacer. In embodiments of this nature, the spacer 50 includes a corner, and the method includes operating the robot arm 10 to move the corner of the spacer 50 through the sealant-application zone while simultaneously operating the sealant applicator 90 or 90′ to rotate the two confronting nozzles 190 about the sealant-application zone. As will be appreciated, the spacer will commonly include multiple corners, and the noted corner operation preferably is performed at each of the corners. In many cases, the spacer will be a rectangular spacer having four corners. In such cases, the method preferably includes operating the robot arm 10 to move each of three or more (optionally to move all four) of the corners through the sealant-application zone while simultaneously operating the sealant applicator 90 or 90′ to rotate the two confronting nozzles 190 about the sealant-application zone.

The two confronting nozzles 190 are rotatable about the sealant-application zone by rotating around a rotation axis, which preferably passes through the sealant-application zone. Preferably, both of the two confronting nozzles 190 lie on the rotation axis. Furthermore, the rotation axis preferably is horizontal or at least generally horizontal (e.g., substantially horizontal). It is to be appreciated, however, that this is not required. As just one example, the rotation axis could be vertical, or at any other desired angle.

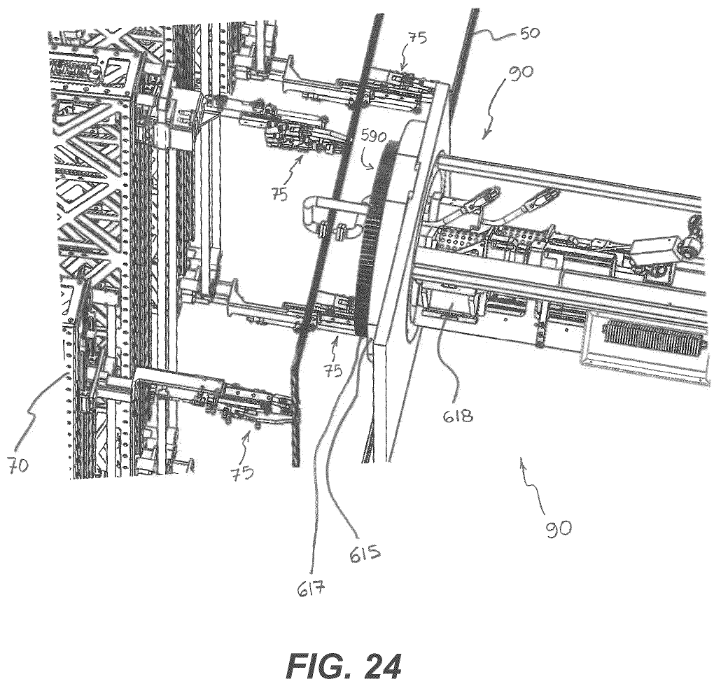

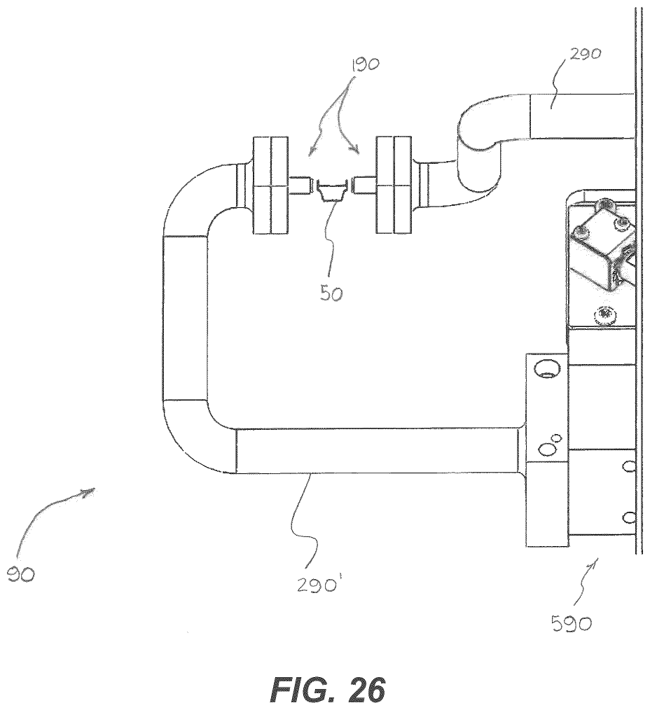

Thus, the noted rotation of the two confronting nozzles 190 preferably is rotation about a rotation axis that is horizontal or at least generally horizontal (e.g., substantially horizontally). During operation, the rotation axis preferably passes through both of the confronting nozzles 190, and through both sides of the spacer 50. This can be appreciated, for example, with reference to the non-limiting example of FIG. 26. This axis may also pass through the dispenser head 590, the gripper frame 70, or both. This is perhaps best appreciated by referring to FIG. 26, either in view of FIG. 22 or in view of FIG. 29 together with FIG. 27.

Preferably, the sealant applicator 90 or 90′ is configured to apply sealant along an entire length of the spacer 50 while the spacer is maintained in a position (optionally an upright position) that is at least substantially fixed rotationally. In some cases, the spacer is maintained in a position that is fixed rotationally throughout the entire process of applying sealant to the spacer. In other cases, the robot arm may rotate the spacer somewhat during operation (such as when going into, around, and/or out of corners). Unlike certain prior methods, however, the spacer preferably is not rotated by 90 degrees each time a corner is turned. That is, the sealant application preferably is not carried out with (i.e., is devoid of) end-over-end spacer rotation. Instead, throughout the application of sealant onto a spacer, the robot arm preferably is operated so as to maintain a bottom leg of the spacer at a bottommost position, while a top leg of the spacer is maintained at a topmost position, and with left and right legs of the spacer maintained respectively at left and right relative positions. This provides advantages in terms of efficiency, seal application quality, and equipment design.

Thus, the spacer 50 will commonly have multiple legs, and the sealant preferably is applied along all legs of the spacer while the robot arm 10 maintains the spacer in a position that is at least substantially fixed rotationally. For example, the robot arm 10 can optionally be configured (and operated) to hold the spacer 50 in a rotationally fixed position (e.g., when moving the spacer linearly) throughout the application of sealant along all legs of the spacer. In some cases, the spacer 50 is a rectangular spacer having four legs, and sealant is applied along all four legs of the spacer while the robot arm 10 maintains the spacer in a position that is at least substantially fixed rotationally (e.g., an upright position, such as an upright, rotationally fixed position). If desired, there may be some spacer rotation going into a corner, going around a corner, and/or coming out of a corner. In other cases, the spacer is fixed rotationally (and held in an upright position) during the entire sealant application process.

In applying sealant along the length of the spacer, rather than beginning and ending sealant application at a corner of the spacer, it may be advantageous to begin and end sealant application with the nozzles 190 located at a desired position along a span of one of the legs of the spacer, such as a midpoint of a bottom leg of the spacer. In such cases, for embodiments involving a rectangular spacer, the method may include rotating the two confronting nozzles 190 four different times. Specifically, rotation of the two confronting nozzles 190 about the sealant-application zone may be done at each of the four corners of the spacer 50. In other cases, though, sealant application may begin and end at a corner of the spacer.

As discussed previously, the spacer 50 can optionally include at least one lateral (e.g., front) wall in addition to first and second sidewalls that define the opposed sides of the spacer onto which sealant is applied by operating the two confronting nozzles 190. In some cases, the lateral wall (e.g., a front wall) and the first and second sidewalls are metal, such as stainless steel or aluminum. Thus, the spacer can optionally be a metal spacer. One non-limiting spacer profile example is shown in FIG. 26. Here, the spacer has metal front (or “outer”) and back (or “inner”) walls. It is to be appreciated, however, that the present sealant application methods and apparatuses can be used to apply sealant onto many different types of spacers. Seven non-limiting spacer types are shown in FIG. 21.

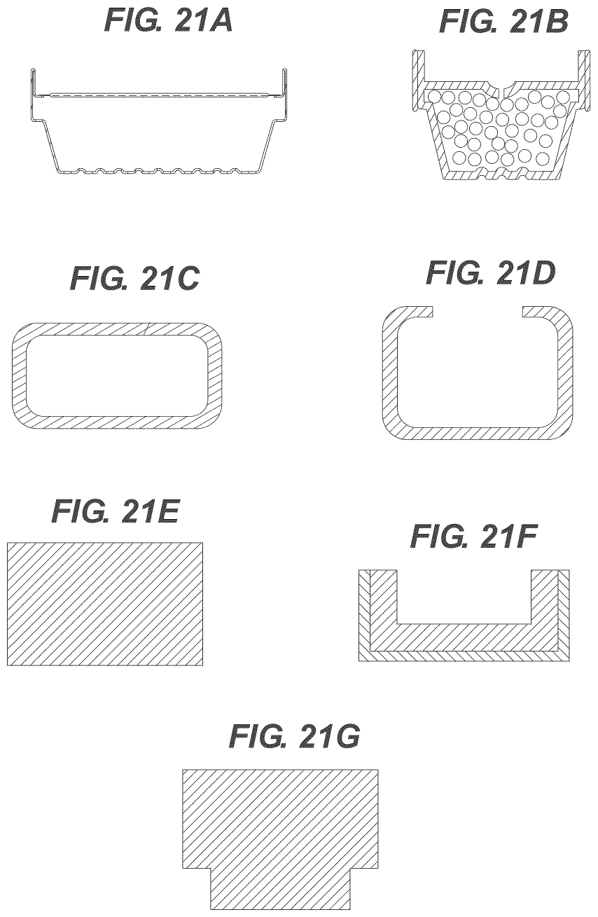

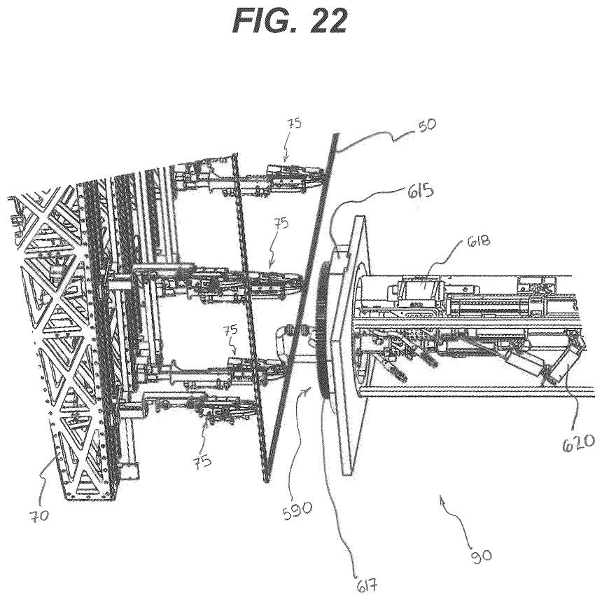

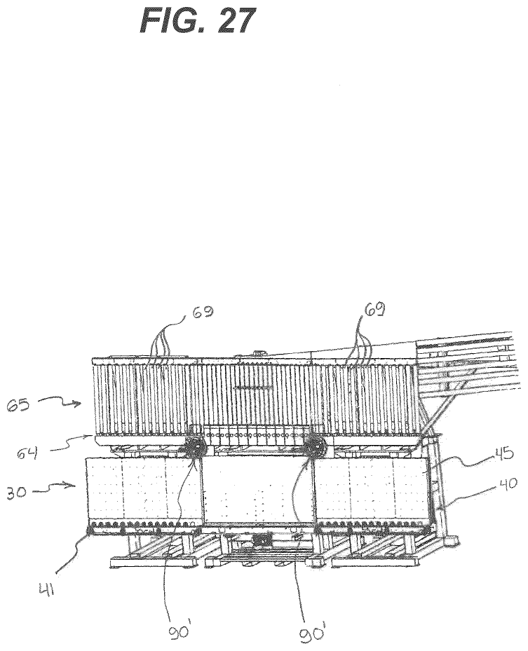

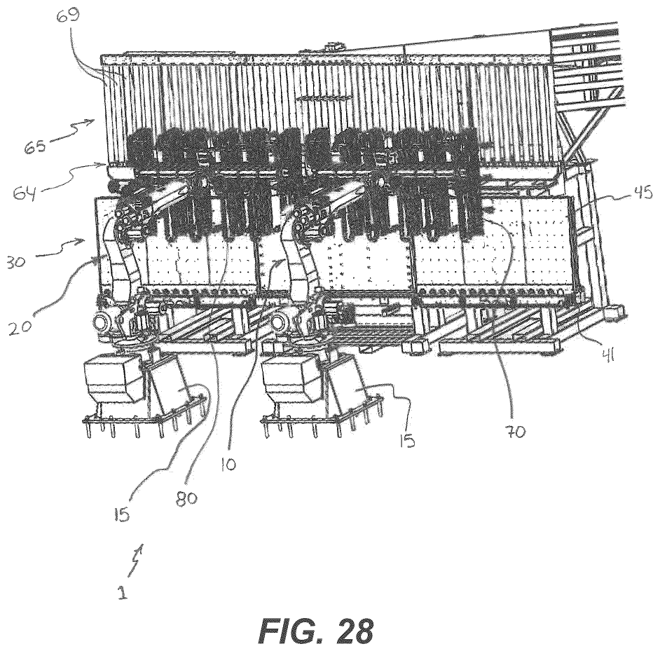

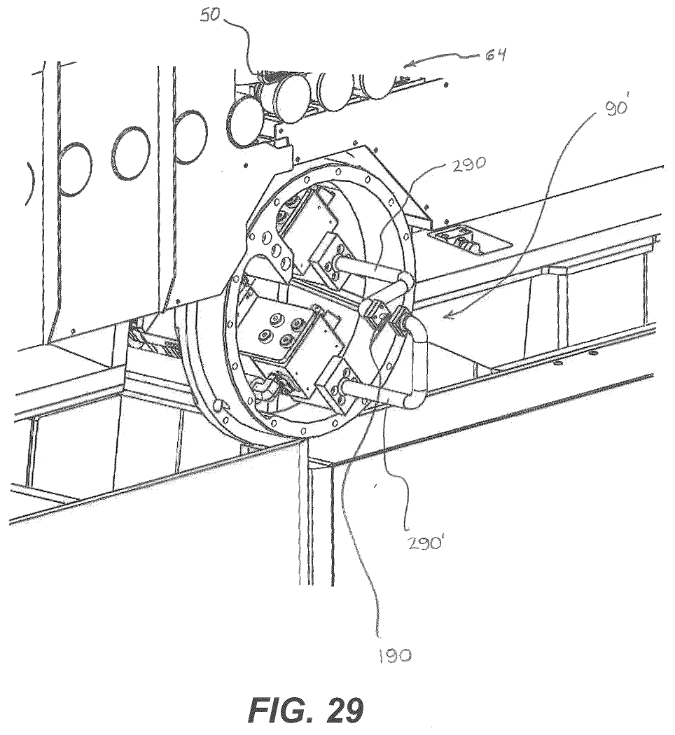

In FIGS. 22-25 and 29-32, the illustrated sealant applicator 90 or 90′ defines a spacer processing channel in which the sealant-application zone is located. In embodiments of this nature, the method includes rotating the two confronting nozzles 190 about the sealant-application zone multiple times (e.g., each time a corner of the spacer is turned), such that the spacer processing channel is sequentially oriented to face in multiple different directions, e.g., at least three different directions, such as four different directions (e.g., upward, leftward, downward and rightward). With continued reference to FIGS. 22-25 and 29-32, the spacer processing channel is shown facing a first direction in FIG. 22 (and FIG. 29), facing a second direction in FIG. 23 (and FIG. 30), facing a third direction in FIG. 24 (and FIG. 31), and facing a fourth direction in FIG. 25 (and FIG. 32). In certain non-limiting examples (e.g., where sealant applicant begins and ends, not at a corner of the spacer but at a midpoint partway along the length of a desired leg of the spacer), the spacer processing channel is sequentially oriented to face upward, leftward, downward, rightward, and upward again. These details, however, are by no means limiting.

In FIGS. 22 and 29, the spacer processing channel faces in an upward direction, whereas in FIGS. 23 and 30, the spacer processing channel faces in a first lateral direction (e.g., leftward, as seen from the perspective of looking from the location of the robot arm toward the sealant dispenser). In FIGS. 24 and 31, the spacer processing channel faces in a downward direction, whereas in FIGS. 25 and 32, the spacer processing channel faces in a second lateral direction (e.g., rightward).

In many cases, the spacer 50 is a multi-sided (e.g., polygonal) spacer having multiple legs, and as noted above, the sealant applicator 90 or 90′ preferably defines (e.g., the nozzle plumbing 290, 290′ bounds) a spacer processing channel in which the sealant-application zone is located. In such cases, as discussed previously, the method preferably includes rotating the two confronting nozzles 190 about the sealant-application zone multiple times, such that the spacer processing channel is sequentially oriented so as to face in at least three different directions. The three or more different directions span at least 180 degrees. In some examples, the spacer 50 is a rectangular spacer having four legs, and the method includes rotating the two confronting nozzles 190 about the sealant-application zone multiple times such that the spacer processing channel is sequentially oriented so as to face in four different directions. In embodiments of this nature, the four different directions preferably span 360 degrees. This was described above in reference to the non-limiting example of FIGS. 22-25 and 29-32.

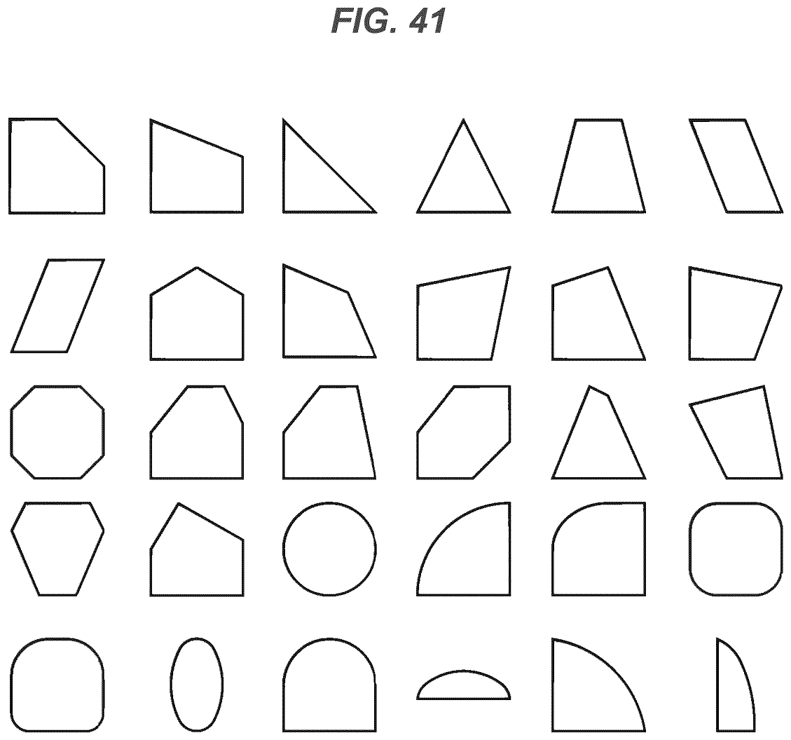

It is to be appreciated, however, that the spacer need not be rectangular. For example, some embodiments involve triangular shapes. Others involve arc shapes. Still other suitable spacer shapes include ellipses, circles, trapezoids, hexagons, octagons, and the like. FIG. 41 shows various non-limiting shape examples for the resulting IG units; the shape of the spacer for such an IG unit will correspond.

In certain embodiments, the sealant applicator 90′ is an integral part of an insulating glazing unit assembly line 30. Reference is made to FIGS. 27-33. Here, the IG unit assembly line 30 comprises a pane conveyor line 40 having a bottom conveyor 41 configured to support a bottom edge of a pane conveyed along the pane conveyor line. Furthermore, the two confronting nozzles 190 of the sealant applicator 90′ preferably are located at a higher elevation than the bottom conveyor 41 of the pane conveyor line 40. As noted above, the bottom conveyor 41 of the pane conveyor line 40 preferably comprises transport rollers and/or one or more conveyor belts. Preferably, the pane conveyor line 40 comprises an upright conveyor wall 45 configured to maintain a pane in a vertical-offset orientation during conveyance along the pane conveyor line. In more detail, the upright conveyor wall 45 preferably comprises a platen, a frame, or both. As is perhaps best shown in FIG. 27, the two confronting nozzles 190 of the illustrated sealant applicator 90′ are located at a higher elevation than an upright conveyor wall 45 (e.g., a platen and/or frame thereof) of the pane conveyor line 40.

With continued reference to FIGS. 27-33, the illustrated system 1 includes a spacer conveyor line 65 located above (e.g., at a higher elevation than, optionally directly above) the IG unit assembly line 30. Thus, the system 1 can optionally be configured to convey spacers along a path of spacer travel passing directly above the sealant applicator 90′.

In some embodiments, the sealant applicator 90′ is located between a spacer conveyor line 65 and the pane conveyor line 40. Thus, the system 1 can optionally be configured to: (i) convey spacers along a path of spacer travel passing directly above the sealant applicator 90′, and (ii) convey glass panes along a path of pane travel passing directly below the sealant applicator 90′. In embodiments of this nature, the path of spacer travel can optionally be parallel (or at least substantially parallel) to the path of the pane travel.

In the non-limiting design illustrated, the sealant applicator 90′ is mounted in a gap (e.g., an elongated horizontal gap) between the spacer conveyor line 65 and an upright conveyor wall 45 of the pane conveyor line 40. As is perhaps best shown in FIGS. 29-32, the sealant applicator 90′ can optionally be received in a pocket, which may be bounded by the spacer conveyor line (e.g., by a wall thereof). In the illustrated embodiment, this pocket is open to the noted gap between the spacer conveyor line 65 and the pane conveyor line 40.

In other embodiments involving a sealant applicator 90′ integrated into an IG unit assembly line 30, there is no spacer conveyor line integrated structurally (e.g., supported by a common framework) with the IG unit assembly line. Instead, a robot arm can be configured to pick spacers from a separate spacer conveyor line (or from a standalone staging area, or from an overhead conveyor), move each spacer to the integrated sealant applicator 90′, and thereby apply sealant onto the spacer 50 using the integrated sealant applicator before pressing the resulting sealant on one side of the spacer against a pane on the IG unit assembly line (so as to adhere the spacer to the pane).

In embodiments involving a sealant applicator 90′ integrated into an IG unit assembly line 30, the applicator preferably includes two confronting nozzles 190 that are rotatable about a sealant-application zone, as already described. Moreover, the illustrated design involves the IG unit assembly line 30 having a backboard structure with the two sealant-delivery tubes 290, 290′ of the applicator 90′ projecting outwardly away from the backboard structure in a cantilevered fashion.

In FIGS. 27-33, the illustrated system 1 includes two sealant applicators 90′ integrated into the IG unit assembly line 30. If desired, however, there can be only a single sealant applicator integrated into the IG unit assembly line.

While the sealant applicator in some embodiments is integrated into an IG unit assembly line, this is not the case for all embodiments. As just one example, a dispenser head 590 like that shown in FIGS. 22-25 and 38-40 can be incorporated into a standalone station (e.g., a PIB pedestal), as shown in FIGS. 1-17C. Thus, a standalone sealant applicator can be mounted at a location spaced apart from both an adjacent IG unit assembly line and a mount base of a robot arm that is operably coupled with the sealant applicator. More generally, a sealant applicator of the nature described above (e.g., having two confronting nozzles rotatable about a sealant-application zone) can be advantageously incorporated into a variety of different types of stations.

One group of embodiments involves a robot arm 10 or 20 equipped with an advantageous gripper frame 70 or 80. Some embodiments of this group provide such a robot arm 10 or 20 on its own, whereas other embodiments provide it in combination (e.g., operably coupled) with a sealant applicator 90 or 90′. Moreover, certain combination embodiments of this nature include the sealant applicator 90′ integrated into an IG unit assembly line 30. Other combination embodiments include the sealant applicator 90 as a standalone applicator (e.g., a PIB pedestal). Thus, some embodiments provide a robotic spacer processing system 1 comprising a robot arm 10 or 20 and a sealant applicator 90 or 90′, where the robot arm is equipped with an advantageous gripper frame 70 or 80.

In the present embodiment group, when a sealant applicator 90 or 90′ is provided, it can optionally comprise two confronting nozzles 190 that have a sealant-application zone between them and are configured to apply sealant onto two opposed sides of the spacer 50, as described above. This is not required in the present embodiments, however, as the present robot arm equipped with an advantageous gripper frame can be used with different types of sealant applicators.

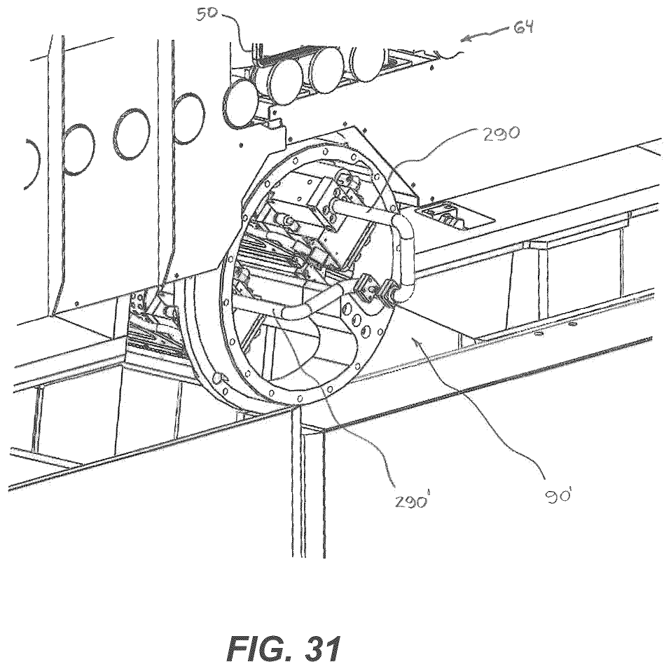

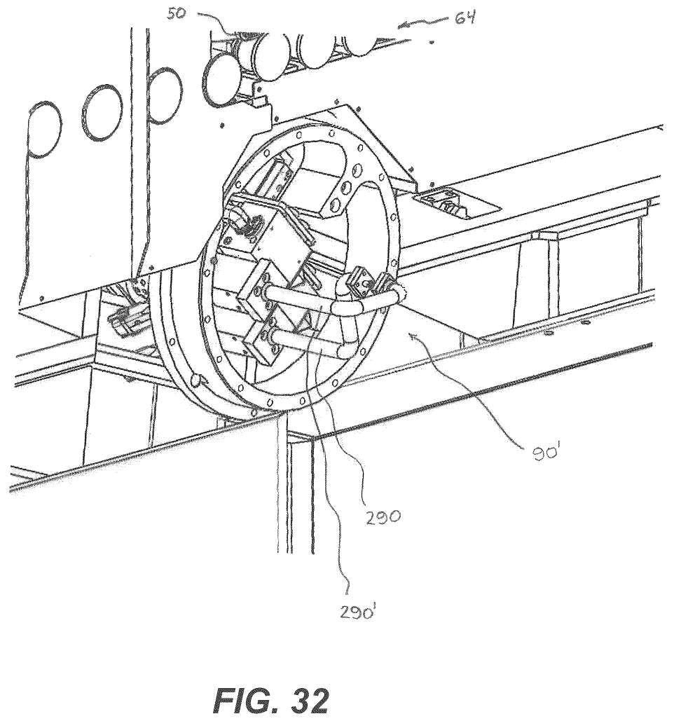

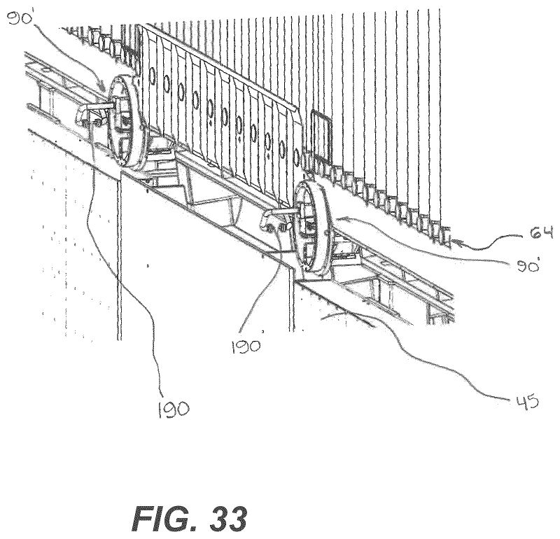

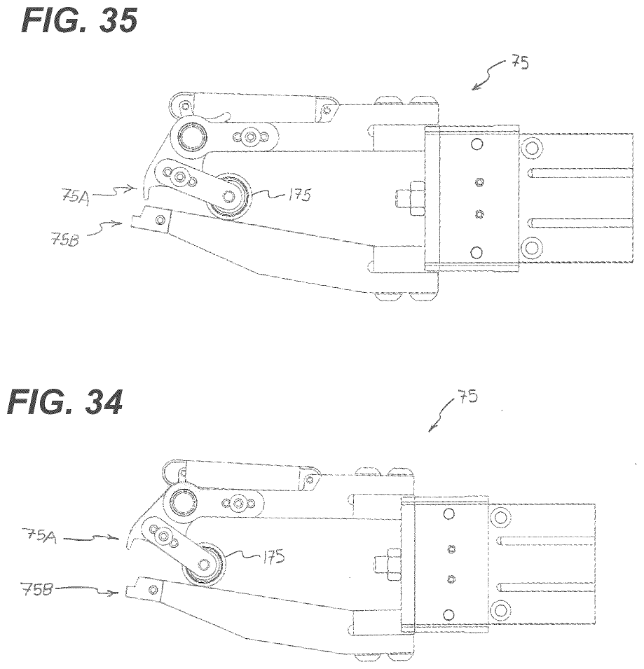

The gripper frame 70 or 80 includes a plurality of grippers configured to hold a spacer 50. This is perhaps best appreciated by referring FIGS. 22-25 in view of FIGS. 34-37. Preferably, each gripper 75 has an open position (see FIGS. 34 and 36) and a closed position (see FIGS. 35 and 37). In more detail, each illustrated gripper 75 preferably includes a pair of cooperating fingers 75A, 75B that are movable selectively toward or away from each other. While the illustrated design involves fingers, other types of cooperating engagement bodies can be used. For example, various types of cooperating jaws can be used. Thus, the following descriptions of fingers are to be understood to also refer to any engagement bodies, such as various types of cooperating jaws.

In the non-limiting embodiment shown in FIGS. 34-37, each pair of cooperating fingers comprises a first finger 75A and a second finger 75B, with at least one of the fingers configured to pivot when moved toward or away from the other. As exemplified by the gripper design shown in these four figures, the first finger 75A of each pair of cooperating fingers can optionally be configured to pivot simultaneously about two axes. Additionally or alternatively, the second finger 75B can optionally be configured to pivot about a single axis. This is the case for the non-limiting example of FIGS. 34-37.

In these and certain other embodiments of the present group, the two fingers 75A, 75B are configured to simultaneously move toward a spacer 50 to be gripped (e.g., while moving toward each other), and later when it is desired to release the spacer, the two fingers can be simultaneously moved away from the spacer (e.g., while moving away from each other). This is perhaps best appreciated by comparing FIGS. 36 and 37. In other cases, just one of two fingers is configured to move toward the other finger (so as to grip a spacer), with the other finger remaining stationary.

Furthermore, in the gripper embodiment detailed in FIGS. 34-37, the first finger 75A is equipped with a roller 175 configured to engage and roll along the second finger 75B so as to actuate a clamping action of the two fingers 75A, 75B onto the spacer 50. This can be appreciated by referring to FIGS. 36 and 37. Instead of a roller, a cam could be used. Either way, the resulting clamping action involves the first finger 75A moving in a direction (e.g., a partially horizontal or lateral direction) so as to engage an interior side surface of an ear of the illustrated spacer. It is to be appreciated, however, that the present embodiments extend to various other gripper configurations configured for gripping different types of spacers (see, e.g., the non-limiting examples of FIG. 21).

Preferably, at least some of the grippers are also retractable grippers, e.g., which are each movable between a retracted position and an extended position. In embodiments of this nature, each retractable gripper when in the extended position projects further from base of the gripper frame than when in the retracted position. In more detail, each retractable gripper when in the extended position is positioned to grip a spacer. Furthermore, when a retractable gripper is in the extended position, it preferably is configured to move between open and closed positions, as discussed above (e.g., including a clamping action), so as to respectively grip and release a spacer.

Thus, in certain embodiments, each of a plurality of retractable grippers 75 is configured to move selectively toward or away from a sealant applicator 90 or 90′ when adjusted between extended and retracted positions.

In more detail, each of the illustrated grippers 75 is configured to move from an engaged position to a disengaged position by: (i) having its first 75A and second 75B fingers move away from each other, thereby separating from the spacer 50, and (ii) travelling in a direction away from the sealant applicator 90 or 90′. Similarly, each of the illustrated grippers 75 is configured to move from the disengaged position to the engaged position by: (i) travelling in a direction toward the sealant applicator 90 or 90′, and (ii) having its first and second fingers move toward each other, thereby gripping the spacer 50.

Preferably, the plurality of grippers 75 includes one or more first grippers positioned to grip a first leg of the spacer, one or more second grippers positioned to grip a second leg of the spacer, one or more third grippers positioned to grip a third leg of the spacer, and one or more fourth grippers positioned to grip a fourth leg of the spacer. Reference is made to FIGS. 22-25. As noted above, the robotic spacer processing system 1 preferably is configured such that the robot arm 10 moves the spacer 50 through the sealant application zone so as to apply sealant along the first leg of the spacer while the one or more first grippers are in the disengaged position, the robot arm moves the spacer through the sealant-application zone so as to apply sealant along the second leg of the spacer while the one or more second grippers are in the disengaged position, the robot arm moves the spacer through the sealant-application zone so as to apply sealant along the third leg of the spacer while the one or more third grippers are in the disengaged position, and the robot arm moves the spacer along the sealant-application zone so as to apply sealant along the fourth leg of the spacer while the one or more fourth grippers are in the disengaged position.

Furthermore, the robotic spacer processing system 1 preferably is configured such that the robot arm 10 moves the spacer 50 through the sealant-application zone so as to apply sealant along the first leg of the spacer while one or more second grippers and one or more third grippers and one or more fourth grippers are in the engaged position, the robot arm moves the spacer through the sealant-application zone so as to apply sealant along the second leg of the spacer while one or more first grippers and one or more third grippers and one or more fourth grippers are in the engaged position, the robot arm moves the spacer through the sealant-application zone so as to apply sealant along the third leg of the spacer while one or more first grippers and one or more second grippers and one or more fourth grippers are in the engaged position, and the robot arm moves the spacer along the sealant-application zone so as to apply sealant along the fourth leg of the spacer while one or more first grippers and one or more second grippers and one or more third grippers are in the engaged position. Again, reference is made to the non-limiting example of FIGS. 22-25.

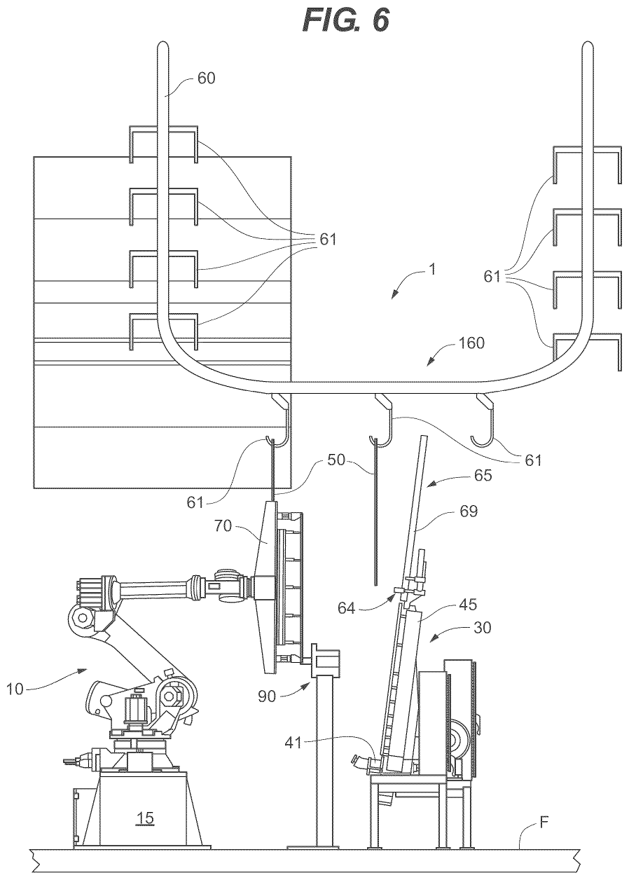

When provided, the sealant applicator 90 or 90′ preferably is located at an elevated position such that a bottom leg of the spacer 50 is at (e.g., is always maintained at) a lower elevation than a top leg of the spacer while the two confronting nozzles 190 are applying sealant onto the two opposed sides of the spacer, and while applying sealant along the top leg of the spacer. Thus, the sealant applicator preferably is configured (and related methods preferably are performed) such that the sealant is applied along all the legs of the spacer without ever rotating the spacer end-over-end in order to apply the sealant on all the legs of the spacer. This can optionally be the case for any embodiment of the present disclosure. Reference is made to the non-limiting examples of FIGS. 6-8, 22-25, 27-28, and 29-33.

In the system and methods described above for operating the robot arm while holding the spacer and thereby moving the spacer along the sealant-application zone of the sealant applicator 90 or 90′ while operating the sealant applicator to apply the sealant onto the spacer, the following is one suitable control sequence. The robot moves along a pre-programmed path for the particular spacer to be processed. Because individual spacers tend not to be perfectly formed, the robot adjusts to the actual shape of each individual spacer. It can do this with a Fanuc software tool called “Dynamic Path Modification” (DPM). This tool is informed by a profile sensor, which is positioned in front of the spacer. The sensor is mounted to the dispenser head ahead of the nozzle along the path of the robot. The sensor sees the shape of the spacer and provides feedback to the robot with regard to where the spacer is in relation to the nozzle. This information is then filtered by a PC to provide more reliable and consistent readings. The PC then sends the data to the Fanuc controller via an ethernet network. The robot controller then further conditions the signal using a PID feedback loop to adjust the variable consumed by the DPM software. As the robot follows the path around the spacer with offsets from the pre-programmed path, the controller also logs these offsets to determine the actual shape (or misshape) of the spacer. This log of the actual position and shape of the spacer can then be used to place the spacer accurately centered on the piece of glass on the conveyor. Also, as the robot moves around the spacer, a Fanuc supplied tool called “Dispense Tool” provides anticipated speed feedback. Because there is significant latency in any dispense system, determining how fast to pump the sealant (e.g., PIB) can be a challenge. This can be managed using the Dispense Tool, which provides the current pump speed to achieve the correct volume of sealant (e.g., PIB) at some point in the future, depending on the speed and acceleration of the robot. It is to be appreciated that these details are merely examples; they are by no means limiting to any embodiment of the invention.

Various examples have been described. These and other examples are within the scope of the following claims.

### EMBODIMENTS

### Group 1

1. A method of operating a robotic spacer processing system comprising an insulating glazing unit assembly line, a spacer conveyor system, a sealant applicator, and a first robot arm, the first robot arm equipped with a first gripper frame, the robotic spacer processing system having an intermediate position, the robotic spacer processing system when in the intermediate position having the first gripper frame holding a spacer adjacent the sealant applicator, and the robotic spacer processing system when in the intermediate position is configured to apply sealant onto opposed sides of the spacer, the method comprising applying the sealant onto the spacer by operating the first robot arm to move the spacer along a nozzle of the sealant applicator so as to apply the sealant along all legs of the spacer while the first robot arm maintains the spacer in an upright rotationally-fixed position.

2. The method of claim 1 wherein the spacer is a rectangular spacer having four legs, and said applying the sealant by operating the first robot arm to move the spacer along the nozzle of the sealant applicator is performed so as to apply the sealant along all four legs of the rectangular spacer while the first robot arm maintains the spacer in the upright rotationally-fixed position.

3 The method of claim 1 or 2 wherein the first robot arm has a mount base that is mounted to a floor, the first robot arm is an articulated robot having multiple rotary joints that provide multiple axes of rotation, the articulated robot having a single robot arm, which is the first robot arm, and the first robot arm equipped with a single gripper frame, which is the first gripper frame.

4. The method of any one of the preceding claims wherein the first robot arm has four or more axes of rotation, and the first robot arm has a mount base that is mounted at a fixed position on a floor.

5. The method of any one of the preceding claims wherein the robotic spacer processing system further comprises a second robot arm, the first and second robot arms positioned at spaced apart locations alongside the insulating glazing unit assembly line, such that both the first and second robot arms are on the same side of the insulating glazing unit assembly line.

6. The method of claim 5 wherein the first robot arm has a mount base that is mounted to a floor and the second robot arm has a mount base that is mounted to the floor, the mount base of the second robot arm being spaced apart from the mount base of the first robot arm.

7. The method of any one of the preceding claims wherein the spacer conveyor system comprises a spacer conveyor line above the insulating glazing unit assembly line.

8. The method of any one of the preceding claims wherein the insulating glazing unit assembly line comprises a pane conveyor line, and the method includes conveying a stream of panes along the pane conveyor line, the pane conveyor line comprising an upright conveyor wall configured to maintain the panes in a vertical-offset orientation during conveyance along the pane conveyor line, the upright conveyor wall comprising a platen or frame.

9. The method of claim 7 wherein the spacer conveyor line comprises spaced-apart upright members, the spaced-apart upright members comprising generally vertical rollers.

10. The method of claim 7 or 9 wherein the spacer conveyor line is directly above the insulating glazing unit assembly line.

11. The method of any one of the preceding claims wherein the spacer conveyor line has an elongated assembly line structure, the insulating glazing unit assembly line has an elongated assembly line structure, and the spacer conveyor line extends along above a top region of the insulating glazing unit assembly line such that the elongated assembly line structure of the spacer conveyor line is generally parallel to the elongated assembly line structure of the insulating glazing unit assembly line.

12. The method of any one of the preceding claims wherein the method includes conveying the spacer along the spacer conveyor line in a desired downstream direction, and conveying a glass pane along the insulating glazing unit assembly line in a downstream direction that is generally parallel to said desired downstream direction.

13. The method of any one of the preceding claims wherein the spacer conveyor line has a bottom conveyor configured to support a bottom of the spacer, and the insulating glazing unit assembly line has a bottom conveyor configured to support a bottom edge of each pane conveyed along the insulating glazing unit assembly line.

14. The method of any one of the preceding claims wherein the nozzle of the sealant applicator is at a higher elevation than the bottom conveyor of the insulating glazing unit assembly line, and the bottom conveyor of the spacer conveyor line is at a higher elevation than the nozzle of the sealant applicator.

15. The method of any one of the preceding claims wherein the bottom conveyor of the spacer conveyor line comprises transport rollers and/or one or more conveyor belts.

16. The method of any one of the preceding claims wherein the robotic spacer processing system further includes a second sealant applicator and said two sealant applicators are spaced apart from each other along a downstream direction of the insulating glazing unit assembly line.

17. The method of any one of the preceding claims wherein the sealant is applied to extend continuously along an entire length of the spacer.

18. The method of any one of the preceding claims wherein the insulating glazing unit assembly line comprises a pane conveyor line having a bottom conveyor configured to support a bottom edge of a pane conveyed along the pane conveyor line, and the nozzle of the sealant applicator is at a higher elevation than the bottom conveyor of the pane conveyor line.

19. The method of any one of the preceding claims wherein the sealant applicator is positioned for use by the first robot arm, the robotic spacer processing system further includes a second robot arm and a second sealant applicator, the first and second robot arms respectively have first and second mount bases that are mounted to a floor at locations spaced apart alongside the insulating glazing unit assembly line, and the second sealant applicator is positioned for use by the second robot arm.

20. A method of operating a robotic spacer processing system comprising a sealant applicator and a robot arm, the sealant applicator comprising two confronting nozzles having a sealant-application zone between them, the method comprising operating the robot arm so as to move the spacer through the sealant-application zone while operating the two confronting nozzles to apply sealant onto two opposed sides of the spacer, wherein the method includes rotating the two confronting nozzles about the sealant-application zone.

21. The method of claim 20 wherein the spacer includes a corner, and the method includes operating the robot to move the corner of the spacer through the sealant-application zone while simultaneously operating the sealant applicator to rotate the two confronting nozzles about the sealant-application zone.

22. The method of claim 20 or 21 wherein the spacer is a rectangular spacer having four corners, and the method includes operating the robot to move each of the four corners through the sealant-application zone while simultaneously operating the sealant applicator to rotate the two confronting nozzles about the sealant-application zone.

23. The method of any one of the preceding claims wherein the spacer has multiple legs, and the sealant is applied along all the legs of the spacer while the robot arm maintains the spacer in a position that is at least substantially fixed rotationally.

24. The method of any one of the preceding claims wherein the spacer is a rectangular spacer having four legs, and the sealant is applied along all four legs of the spacer while the robot arm maintains the spacer in a position that is at least substantially fixed rotationally.

25. The method of any one of the preceding claims wherein the spacer is a metal spacer that includes a metal front wall in addition to first and second metal sidewalls that define the opposed sides of the spacer onto which sealant is applied by said operating the two confronting nozzles.

26. The method of any one of the preceding claims wherein the spacer is a rectangular spacer having multiple legs, the sealant applicator defines a spacer processing channel in which the sealant-application zone is located, and the method includes rotating the two confronting nozzles about the sealant-application zone multiple times such that the spacer processing channel is sequentially oriented so as to face in at least three different directions, the three different directions spanning at least 180 degrees.

27. The method of any one of the preceding claims wherein the spacer is a rectangular spacer having four legs, the sealant applicator defines a spacer processing channel in which the sealant-application zone is located, and the method includes rotating the two confronting nozzles about the sealant-application zone multiple times such that the spacer processing channel is sequentially oriented so as to face in at least four different directions, the four different directions spanning 360 degrees.

28. The method of any one of the preceding claims wherein the sealant applicator comprises a dispenser head, and when the spacer is moved through the sealant-application zone a first of the two opposed sides of the spacer faces toward the dispenser head and a second of the two opposed sides of the spacer faces away from the dispenser head, such that a first of the two confronting nozzles applies sealant onto the first of the two opposed sides of the spacer while a second of the two confronting nozzles applies the sealant onto the second of the two opposed sides of the spacer.

29. The method of any one of the preceding claims wherein the sealant applicator is disposed at an elevated position, and the method involves maintaining a bottom leg of the spacer at a lower elevation than a top leg of the spacer while the two confronting nozzles are applying the sealant onto the two opposed sides of the spacer along the top leg of the spacer.

### Group 2

1. A sealant applicator configured to apply sealant onto two opposed sides of a spacer, the sealant applicator comprising two confronting nozzles having a sealant-application zone between them, the two confronting nozzles being rotatable about the sealant-application zone.

2. The sealant applicator of claim 1 wherein the sealant applicator is disposed at an elevated position, such that a bottom leg of the spacer is at a lower elevation than a top leg of the spacer when the two confronting nozzles are positioned to apply the sealant onto the two opposed sides of the spacer along the top leg of the spacer.

3. The sealant applicator of claim 1 or 2 wherein the sealant applicator comprises a dispenser head, the sealant applicator configured such that when the spacer is positioned in the sealant-application zone with a first of the two opposed sides of the spacer facing toward the dispenser head and a second of the two opposed sides of the spacer facing away from the dispenser head, a first of the two confronting nozzles is positioned to apply the sealant onto the first of the two opposed sides of the spacer while a second of the two confronting nozzles is positioned to apply the sealant onto the second of the two opposed sides of the spacer.

4. The sealant applicator of any one of the preceding claims wherein the two confronting nozzles are disposed respectively on two sealant-delivery tubes that both project away from the dispenser head.

5. The sealant applicator of any one of the preceding claims wherein the sealant applicator includes a supply of PIB configured to provide PIB to the two confronting nozzles via the two sealant-delivery tubes.

6. The sealant applicator of any one of the preceding claims wherein the two confronting nozzles are rotatable about the sealant-application zone by rotating around a rotation axis that passes through the sealant-application zone.

7. The sealant applicator of claim 6 wherein both of the two confronting nozzles lie on the rotation axis.

8. The sealant applicator of claim 6 or 7 wherein the rotation axis is at least generally horizontal.

9. The sealant applicator of any one of the preceding claims wherein the sealant applicator comprises a dispenser head having a generally cylindrical configuration.

10. The sealant applicator of any one of the preceding claims wherein the spacer has four corners, and the sealant applicator is configured such that when the sealant applicator applies sealant to one of the four corners the two confronting nozzles rotate about the sealant-application zone.

11. The sealant applicator of any one of the preceding claims wherein the sealant applicator is configured such that the sealant-application zone does not move linearly, but rather remains in a substantially fixed location, at all times during operation of the sealant applicator.

12. The sealant applicator of any one of the preceding claims wherein the sealant applicator is configured to apply the sealant along an entire length of the spacer while the spacer is maintained in a position that is at least substantially fixed rotationally.

13. The sealant applicator of any one of the preceding claims wherein the sealant applicator is configured to apply the sealant along an entire length of the spacer while the spacer is maintained in an upright position that is at least substantially fixed rotationally.

14. The sealant applicator of any one of the preceding claims wherein the sealant applicator defines a spacer processing channel in which the sealant-application zone is located, the two confronting nozzles being rotatable about the sealant-application zone such that the spacer processing channel can be sequentially oriented to face in at least three different directions, the three different directions spanning at least 180 degrees.

15. The sealant applicator of any one of the preceding claims wherein the sealant applicator defines a spacer processing channel in which the sealant-application zone is located, the two confronting nozzles being rotatable about the sealant-application zone such that the spacer processing channel can be sequentially oriented to face in at least four different directions, the four different directions spanning 360 degrees.

16. The sealant applicator of any one of the preceding claims wherein the sealant applicator is an integral part of an insulating glazing unit assembly line.

17. The sealant applicator of claim 16 wherein the insulating glazing unit assembly line comprises a pane conveyor line having a bottom conveyor configured to support a bottom edge of a pane conveyed along the pane conveyor line, and the two confronting nozzles of the sealant applicator are located at a higher elevation than the bottom conveyor of the pane conveyor line.

18. The sealant applicator of claim 17 wherein the bottom conveyor of the pane conveyor line comprises transport rollers and/or one or more conveyor belts.

19. The sealant applicator of claim 17 or 18 wherein the pane conveyor line comprises an upright conveyor wall configured to maintain the pane in a vertical-offset orientation during conveyance along the pane conveyor line, the upright conveyor wall comprising a platen or frame, and the two confronting nozzles of the sealant applicator are located at a higher elevation than the platen or frame of the pane conveyor line.

20. A robotic spacer processing system comprising a robot arm and a sealant applicator, the robot arm equipped with a gripper frame, the gripper frame including a plurality of grippers configured to hold a spacer, the sealant applicator comprising two confronting nozzles that have a sealant-application zone between them and are configured to apply sealant onto two opposed sides of the spacer, the grippers being retractable grippers that are each movable between an engaged position and a disengaged position, the sealant applicator disposed at an elevated position such that a bottom leg of the spacer is at a lower elevation than a top leg of the spacer while the two confronting nozzles are applying the sealant onto the two opposed sides of the spacer along the top leg of the spacer.

21. The robotic spacer processing system of claim 20 wherein each of the retractable grippers comprises a pair of cooperating fingers that are movable selectively toward or away from each other.

22. The robotic spacer processing system of claim 21 wherein each pair of cooperating fingers comprises a first finger and a second finger, such that one or both of the first and second fingers are configured to pivot when moved toward or away from each other.

23. The robotic spacer processing system of claim 22 wherein the first finger of each pair of cooperating fingers is configured to pivot simultaneously about two axes.

24. The robotic spacer processing system of claim 22 or 23 wherein the second finger of each pair of cooperating fingers is configured to pivot about a single axis.

25. The robotic spacer processing system of any one of the preceding claims wherein each of the retractable grippers is configured to move selectively toward or away from the sealant applicator when moved between the engaged and disengaged positions.

26. The robotic spacer processing system of any one of the preceding claims wherein each of the retractable grippers is configured to move from the engaged position to the disengaged position by: (i) having its first and second fingers move away from each other, thereby separating from the spacer, and (ii) moving in a direction away from the sealant applicator, and wherein each of the retractable grippers is configured to move from the disengaged position to the engaged position by: (i) travelling in a direction toward the sealant applicator, and (ii) having its first and second fingers move toward each other, thereby gripping the spacer.

27. The robotic spacer processing system of any one of the preceding claims wherein the plurality of grippers includes one or more first grippers positioned to grip a first leg of the spacer, one or more second grippers positioned to grip a second leg of the spacer, one or more third grippers positioned to grip a third leg of the spacer, and one or more fourth grippers positioned to grip a fourth leg of the spacer, the robotic spacer processing system configured such that the robot arm moves the spacer through the sealant-application zone so as to apply sealant along the first leg of the spacer while the one or more first grippers are in the disengaged position, the robot arm moves the spacer through the sealant-application zone so as to apply sealant along the second leg of the spacer while the one or more second grippers are in the disengaged position, the robot arm moves the spacer through the sealant-application zone so as to apply sealant along the third leg of the spacer while the one or more third grippers are in the disengaged position, and the robot arm moves the spacer along the sealant-application zone so as to apply sealant along the fourth leg of the spacer while the one or more fourth grippers are in the disengaged position.

28. The robotic spacer processing system of claim 27 wherein the robotic spacer processing system is configured such that the robot arm moves the spacer through the sealant-application zone so as to apply sealant along the first leg of the spacer while the one or more second grippers and the one or more third grippers and the one or more fourth grippers are in the engaged position, the robot arm moves the spacer through the sealant-application zone so as to apply sealant along the second leg of the spacer while the one or more first grippers and the one or more third grippers and the one or more fourth grippers are in the engaged position, the robot arm moves the spacer through the sealant-application zone so as to apply sealant along the third leg of the spacer while the one or more first grippers and the one or more second grippers and the one or more fourth grippers are in the engaged position, and the robot arm moves the spacer along the sealant-application zone so as to apply sealant along the fourth leg of the spacer while the one or more first grippers and the one or more second grippers and the one or more third grippers are in the engaged position.

29. The robotic spacer processing system of any one of the preceding claims wherein the two confronting nozzles of the sealant applicator are rotatable about the sealant-application zone.

30. The robotic spacer processing system of any one of the preceding claims wherein the robotic spacer processing system includes an insulating glazing unit assembly line, and the sealant applicator is an integral part of the insulating glazing unit assembly line.

31. The sealant applicator of claim 30 wherein the insulating glazing unit assembly line comprises a pane conveyor line having a bottom conveyor configured to support a bottom edge of a pane conveyed along the pane conveyor line, and the two confronting nozzles of the sealant applicator are located at a higher elevation than the bottom conveyor of the pane conveyor line.

32. The sealant applicator of claim 31 wherein the bottom conveyor of the pane conveyor line comprises transport rollers and/or one or more conveyor belts.

33. The sealant applicator of claim 31 or 32 wherein the pane conveyor line comprises an upright conveyor wall configured to maintain the pane in a vertical-offset orientation during conveyance along the pane conveyor line, the upright conveyor wall comprising a platen or frame, and the two confronting nozzles of the sealant applicator are located at a higher elevation than the platen or frame of the pane conveyor line.

34. The robotic spacer processing system of any one of the preceding claims wherein the robot arm has a mount base that is mounted to a floor, the robot arm is an articulated robot having multiple rotary joints that provide multiple axes of rotation, the articulated robot has only a single robot arm, which is the robot arm, and the robot arm is equipped with only a single gripper frame, which is the gripper frame.

35. The robotic spacer processing system of any one of the preceding claims wherein the first robot arm has four or more axes of rotation.

36. The robotic spacer processing system of any one of the preceding claims wherein the sealant applicator comprises a dispenser head, the sealant applicator configured such that when the spacer is positioned in the sealant-application zone with a first of the two opposed sides of the spacer facing toward the dispenser head and a second of the two opposed sides of the spacer facing away from the dispenser head, a first of the two confronting nozzles is positioned to apply the sealant onto the first of the two opposed sides of the spacer while a second of the two confronting nozzles is positioned to apply the sealant onto the second of the two opposed sides of the spacer.

37. The robotic spacer processing system of any one of the preceding claims wherein the sealant applicator includes a supply of PIB.

38. A robotic spacer processing system comprising a robot arm and an insulating glazing unit assembly line, the robotic spacer processing system including a sealant applicator that is integral to the insulating glazing unit assembly line, the sealant applicator comprising two confronting nozzles having a sealant-application zone between them, the robot arm configured to move a spacer through the sealant-application zone of the sealant applicator while operating the two confronting nozzles to apply sealant onto two opposed sides of the spacer.

39. The robotic spacer processing system of claim 38 wherein the insulating glazing unit assembly line comprises a pane conveyor line, the pane conveyor line comprising an upright conveyor wall comprising a platen, a frame, or both.

40. The robotic spacer processing system of claim 38 or 39 wherein the sealant applicator is located above the upright conveyor wall.

41. The robotic spacer processing system of claim 39 or 40 including a framework that supports both the upright conveyor wall and the sealant applicator.

42. The robotic spacer processing system of claim 41 wherein the framework has a base positioned on a floor.

43. The robotic spacer processing system of any one of the preceding claims wherein the sealant applicator comprises a dispenser head having a generally cylindrical configuration.

44. The robotic spacer processing system of any one of the preceding claims wherein the insulating glazing unit assembly line comprises a pane conveyor line having a bottom conveyor configured to support a bottom edge of a pane conveyed along the pane conveyor line, and the two confronting nozzles of the sealant applicator are located at a higher elevation than the bottom conveyor of the pane conveyor line.

45. The robotic spacer processing system of any one of the preceding claims wherein the sealant applicator is configured such that its two confronting nozzles are rotatable about the sealant-application zone.

46. The robotic spacer processing system of any one of the preceding claims wherein the sealant applicator comprises a dispenser head, the sealant applicator configured such that when the spacer is positioned in the sealant-application zone with a first of the two opposed sides of the spacer facing toward the dispenser head and a second of the two opposed sides of the spacer facing away from the dispenser head, a first of the two confronting nozzles is positioned to apply the sealant onto the first of the two opposed sides of the spacer while a second of the two confronting nozzles is positioned to apply the sealant onto the second of the two opposed sides of the spacer.

47. The robotic spacer processing system of any one of the preceding claims wherein the robot arm has six axes of rotation.

48. The robotic spacer processing system of any one of the preceding claims wherein the robot arm has a mount base that is mounted to a floor, the robot arm is an articulated robot having multiple rotary joints that provide multiple axes of rotation, the articulated robot has only a single robot arm, which is the robot arm, and the robot arm is equipped with only a single gripper frame, which is the gripper frame.

49. The robotic spacer processing system of any one of the preceding claims wherein the sealant applicator is located at an elevated position, such that a bottom leg of the spacer is at a lower elevation than a top leg of the spacer when the two confronting nozzles are positioned to apply the sealant onto the two opposed sides of the spacer along the top leg of the spacer.

1. A robotic spacer processing system comprising a robot arm and a sealant applicator, the robot arm equipped with a gripper frame, the gripper frame including a plurality of grippers configured to hold a spacer, the sealant applicator comprising two confronting nozzles that have a sealant-application zone between them and are configured to apply sealant onto two opposed sides of the spacer, the grippers being retractable grippers that are each movable between an engaged position and a disengaged position, the sealant applicator disposed at an elevated position such that a bottom leg of the spacer is at a lower elevation than a top leg of the spacer while the two confronting nozzles are applying the sealant onto the two opposed sides of the spacer along the top leg of the spacer.

2. The robotic spacer processing system of claim 1 wherein each of the retractable grippers comprises a pair of cooperating fingers that are movable selectively toward or away from each other.

3. The robotic spacer processing system of claim 2 wherein each pair of cooperating fingers comprises a first finger and a second finger, such that one or both of the first and second fingers are configured to pivot when moved toward or away from each other.

4. The robotic spacer processing system of claim 3 wherein the first finger of each pair of cooperating fingers is configured to pivot simultaneously about two axes.

5. The robotic spacer processing system of claim 4 wherein the second finger of each pair of cooperating fingers is configured to pivot about a single axis.

6. The robotic spacer processing system of claim 1 wherein each of the retractable grippers is configured to move selectively toward or away from the sealant applicator when moved between the engaged and disengaged positions.

7. The robotic spacer processing system of claim 1 wherein each of the retractable grippers is configured to move from the engaged position to the disengaged position by: (i) having its first and second fingers move away from each other, thereby separating from the spacer, and (ii) moving in a direction away from the sealant applicator, and wherein each of the retractable grippers is configured to move from the disengaged position to the engaged position by: (i) travelling in a direction toward the sealant applicator, and (ii) having its first and second fingers move toward each other, thereby gripping the spacer.

8. The robotic spacer processing system of claim 1 wherein the plurality of grippers includes one or more first grippers positioned to grip a first leg of the spacer, one or more second grippers positioned to grip a second leg of the spacer, one or more third grippers positioned to grip a third leg of the spacer, and one or more fourth grippers positioned to grip a fourth leg of the spacer, the robotic spacer processing system configured such that the robot arm moves the spacer through the sealant-application zone so as to apply sealant along the first leg of the spacer while the one or more first grippers are in the disengaged position, the robot arm moves the spacer through the sealant-application zone so as to apply sealant along the second leg of the spacer while the one or more second grippers are in the disengaged position, the robot arm moves the spacer through the sealant-application zone so as to apply sealant along the third leg of the spacer while the one or more third grippers are in the disengaged position, and the robot arm moves the spacer along the sealant-application zone so as to apply sealant along the fourth leg of the spacer while the one or more fourth grippers are in the disengaged position.

9. The robotic spacer processing system of claim 8 wherein the robotic spacer processing system is configured such that the robot arm moves the spacer through the sealant-application zone so as to apply sealant along the first leg of the spacer while the one or more second grippers and the one or more third grippers and the one or more fourth grippers are in the engaged position, the robot arm moves the spacer through the sealant-application zone so as to apply sealant along the second leg of the spacer while the one or more first grippers and the one or more third grippers and the one or more fourth grippers are in the engaged position, the robot arm moves the spacer through the sealant-application zone so as to apply sealant along the third leg of the spacer while the one or more first grippers and the one or more second grippers and the one or more fourth grippers are in the engaged position, and the robot arm moves the spacer along the sealant-application zone so as to apply sealant along the fourth leg of the spacer while the one or more first grippers and the one or more second grippers and the one or more third grippers are in the engaged position.

10. The robotic spacer processing system of claim 1 wherein the two confronting nozzles of the sealant applicator are rotatable about the sealant-application zone.

11. The robotic spacer processing system of claim 1 wherein the robotic spacer processing system includes an insulating glazing unit assembly line, and the sealant applicator is an integral part of the insulating glazing unit assembly line.

12. The sealant applicator of claim 11 wherein the insulating glazing unit assembly line comprises a pane conveyor line having a bottom conveyor configured to support a bottom edge of a pane conveyed along the pane conveyor line, and the two confronting nozzles of the sealant applicator are located at a higher elevation than the bottom conveyor of the pane conveyor line.

13. The sealant applicator of claim 12 wherein the bottom conveyor of the pane conveyor line comprises transport rollers and/or one or more conveyor belts.

14. The sealant applicator of claim 12 wherein the pane conveyor line comprises an upright conveyor wall configured to maintain the pane in a vertical-offset orientation during conveyance along the pane conveyor line, the upright conveyor wall comprising a platen or frame, and the two confronting nozzles of the sealant applicator are located at a higher elevation than the platen or frame of the pane conveyor line.

15. The robotic spacer processing system of claim 1 wherein the robot arm has a mount base that is mounted to a floor, the robot arm is an articulated robot having multiple rotary joints that provide multiple axes of rotation, the articulated robot has only a single robot arm, which is the robot arm, and the robot arm is equipped with only a single gripper frame, which is the gripper frame.

16. The robotic spacer processing system of claim 15 wherein the first robot arm has four or more axes of rotation.

17. The robotic spacer processing system of claim 1 wherein the sealant applicator comprises a dispenser head, the sealant applicator configured such that when the spacer is positioned in the sealant-application zone with a first of the two opposed sides of the spacer facing toward the dispenser head and a second of the two opposed sides of the spacer facing away from the dispenser head, a first of the two confronting nozzles is positioned to apply the sealant onto the first of the two opposed sides of the spacer while a second of the two confronting nozzles is positioned to apply the sealant onto the second of the two opposed sides of the spacer.

18. The robotic spacer processing system of claim 1 wherein the sealant applicator includes a supply of PIB.

19. A robotic spacer processing system comprising a robot arm and an insulating glazing unit assembly line, the robotic spacer processing system including a sealant applicator that is integral to the insulating glazing unit assembly line, the sealant applicator comprising two confronting nozzles having a sealant-application zone between them, the robot arm configured to move a spacer through the sealant-application zone of the sealant applicator while operating the two confronting nozzles to apply sealant onto two opposed sides of the spacer.

20. The robotic spacer processing system of claim 19 wherein the insulating glazing unit assembly line comprises a pane conveyor line, the pane conveyor line comprising an upright conveyor wall comprising a platen, a frame, or both.

21. The robotic spacer processing system of claim 20 wherein the sealant applicator is located above the upright conveyor wall.

22. The robotic spacer processing system of claim 20 including a framework that supports both the upright conveyor wall and the sealant applicator.

23. The robotic spacer processing system of claim 22 wherein the framework has a base positioned on a floor.

24. The robotic spacer processing system of claim 19 wherein the sealant applicator comprises a dispenser head having a generally cylindrical configuration.

25. The robotic spacer processing system of claim 19 wherein the insulating glazing unit assembly line comprises a pane conveyor line having a bottom conveyor configured to support a bottom edge of a pane conveyed along the pane conveyor line, and the two confronting nozzles of the sealant applicator are located at a higher elevation than the bottom conveyor of the pane conveyor line.

26. The robotic spacer processing system of claim 19 wherein the sealant applicator is configured such that its two confronting nozzles are rotatable about the sealant-application zone.

27. The robotic spacer processing system of claim 19 wherein the sealant applicator comprises a dispenser head, the sealant applicator configured such that when the spacer is positioned in the sealant-application zone with a first of the two opposed sides of the spacer facing toward the dispenser head and a second of the two opposed sides of the spacer facing away from the dispenser head, a first of the two confronting nozzles is positioned to apply the sealant onto the first of the two opposed sides of the spacer while a second of the two confronting nozzles is positioned to apply the sealant onto the second of the two opposed sides of the spacer.

28. The robotic spacer processing system of claim 19 wherein the robot arm has six axes of rotation.

29. The robotic spacer processing system of claim 19 wherein the robot arm has a mount base that is mounted to a floor, the robot arm is an articulated robot having multiple rotary joints that provide multiple axes of rotation, the articulated robot has only a single robot arm, which is the robot arm, and the robot arm is equipped with only a single gripper frame, which is the gripper frame.

30. The robotic spacer processing system of claim 19 wherein the sealant applicator is located at an elevated position, such that a bottom leg of the spacer is at a lower elevation than a top leg of the spacer when the two confronting nozzles are positioned to apply the sealant onto the two opposed sides of the spacer along the top leg of the spacer.
